(19) United States
(12) Patent Application Publication
(10) Pub. No.: US 2026/0281145 A1
(43) Pub. Date: Sep. 17, 2026

(54) SYSTEM

(71) Applicant: SoftBank Group Corp., Tokyo (JP)

(72) Inventor: Takuya MATSUYAMA, Tokyo (JP)

(73) Assignee: SoftBank Group Corp., Tokyo (JP)

(21) Appl. No.: 19/549,308

(22) Filed: Feb. 25, 2026

Related U.S. Application Data
(60) Provisional application No. 63/770,813, filed on Mar. 12, 2025.

(51) Int. Cl. H04L 9/40; G06N 3/0475

(52) U.S. Cl. CPC H04L 63/1433; G06N 3/0475

(57) ABSTRACT

A system includes a processor configured to learn data regarding technical information and security vulnerabilities and to analyze the data using natural language processing techniques and machine learning algorithms applied to existing attack methods. The processor generates new attack patterns based on the analyzed data and methods, identifies characteristics and weaknesses represented by the generated attack patterns, and updates rule sets of an intrusion detection system, optimizes firewall settings, and generates vulnerability patches based on the identified characteristics and weaknesses. The processor executes virtual attacks in a simulation environment to verify effectiveness of the updated rule sets, optimized firewall settings, and generated patches, improves defense measures based on simulation results, and maintains security software in a state capable of responding to latest threats using the improved defense measures.

### CROSS-REFERENCE TO RELATED APPLICATION

This application claims the benefit of U.S. Provisional Application No. 63/770,813, filed on Mar. 12, 2025, pursuant to 35 U.S.C. § 119(e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional security systems typically rely on static rule sets, manually created signatures, and periodic updates that are not sufficiently responsive to rapidly evolving cyber threats. As new attack methods and unknown vulnerabilities emerge, such systems often fail to detect or mitigate sophisticated attacks in a timely manner. Manual analysis of large volumes of security-related information, such as public security reports, academic papers, technical blogs, and forum posts, requires significant expert resources and is prone to delay and human error. Furthermore, existing solutions do not adequately integrate automated attack pattern generation, automated development of corresponding defense measures, and simulation-based evaluation in a unified, continuously improving framework. As a result, it is difficult to maintain security software in a state that can effectively respond to the latest and previously unknown threats while minimizing operational burden on administrators.

### SUMMARY

In order to solve the above-described problems, a system is provided that comprises a processor configured to perform integrated processing from data acquisition and analysis to attack pattern generation, defense development, and simulation-based evaluation. The processor is configured to learn data regarding latest technical information and security vulnerabilities, analyze the data using natural language processing techniques, analyze existing attack methods using machine learning algorithms, and generate new attack patterns based on the analyzed data and the analyzed existing attack methods. The processor is further configured to receive the generated attack patterns, identify characteristics and weaknesses of attacks represented by the generated attack patterns, update rule sets of an intrusion detection system, optimize firewall settings, and generate patches for correcting vulnerabilities on the basis of the identified characteristics and weaknesses. In addition, the processor is configured to execute virtual attacks in a simulation environment in order to verify effectiveness of the updated rule sets, the optimized firewall settings, and the generated patches, and to improve the defense measures based on results of the executed virtual attacks. By continuously repeating this cycle, the system maintains security software in a state capable of responding to latest and unknown threats, while reducing the need for manual intervention and enabling timely, data-driven security enhancements.

The term “processor” refers to one or more hardware computing units, such as a central processing unit (CPU), graphics processing unit (GPU), dedicated accelerator, or any combination thereof, configured to execute instructions to perform the functions described in the claims.

The term “latest technical information” refers to technical data and knowledge that are newly published or recently updated, including but not limited to information about software, hardware, communication protocols, and security techniques that may influence the security posture of systems.

The term “security vulnerabilities” refers to weaknesses, flaws, or misconfigurations in software, hardware, or network configurations that can be exploited by an attacker to compromise confidentiality, integrity, or availability of information or services.

The term “natural language processing techniques” refers to computational methods and algorithms for processing, understanding, and analyzing human language text, including but not limited to tokenization, parsing, entity recognition, classification, and semantic analysis.

The term “machine learning algorithms” refers to computational models and techniques that learn patterns or relationships from data and use such learned patterns or relationships to make predictions, classifications, clusterings, or other inferences without being explicitly programmed for each specific case.

The term “existing attack methods” refers to attack techniques, procedures, and exploit strategies that have already been observed, documented, or otherwise identified in relation to cyber security incidents or vulnerabilities.

The term “attack patterns” refers to structured representations of attack methods, each describing one or more attack steps, conditions, vectors, payloads, targets, and expected impacts that an attacker may use to compromise a system.

The term “new attack patterns” refers to attack patterns that are generated based on analysis of latest technical information, security vulnerabilities, and existing attack methods, and that may include unknown or previously unobserved attack techniques or variants.

The term “intrusion detection system” refers to a system or component that monitors network traffic, host activities, or application behavior to detect potential malicious activities, policy violations, or intrusions by comparing observed events against predefined rules, signatures, or learned models.

The term “rule sets of an intrusion detection system” refers to collections of detection rules, signatures, or conditions that are applied by the intrusion detection system to determine whether observed events indicate potential attacks or suspicious behavior.

The term “firewall settings” refers to configuration parameters and rules used by a firewall, including but not limited to access control lists, port and protocol filters, address filters, rate limits, and logging settings, which collectively determine how network traffic is permitted, restricted, or blocked.

The term “patches for correcting vulnerabilities” refers to software updates, code modifications, configuration changes, or other corrective measures that are applied to a system to eliminate or mitigate identified security vulnerabilities.

The term “simulation environment” refers to a virtual or test environment, including one or more virtual machines, containers, emulated systems, or isolated testbeds, configured to reproduce system configurations and to safely execute virtual attacks without impacting production systems.

The term “virtual attacks” refers to simulated attack executions performed in the simulation environment, using attack patterns to emulate the behavior of actual attackers for the purpose of testing and evaluating defense measures.

The term “defense measures” refers to technical and procedural controls designed to prevent, detect, or mitigate attacks, including but not limited to intrusion detection rules, firewall configurations, patches, and associated monitoring or response mechanisms.

The term “publicly available security reports” refers to documents or publications accessible to the public, such as advisories, incident reports, or vulnerability notices issued by security organizations, vendors, or communities, which describe security vulnerabilities, incidents, or countermeasures.

The term “academic papers” refers to scholarly publications, including journal articles, conference papers, and preprints, that present research results related to computer security, vulnerabilities, attack methods, or defense techniques.

The term “technical blogs” refers to online articles or postings authored by individuals or organizations that provide technical information, analyses, or commentary on security-related topics, including vulnerabilities, exploits, and defensive practices.

The term “forum posts” refers to messages, threads, or discussions published on online forums, message boards, or community platforms in which users share information, questions, or observations related to security issues, vulnerabilities, or attack techniques.

The term “insights regarding unknown threats” refers to knowledge, hypotheses, or inferred characteristics about potential attacks or vulnerabilities that have not yet been directly observed, documented, or widely recognized, but are derived from analysis of available data and generated attack patterns.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

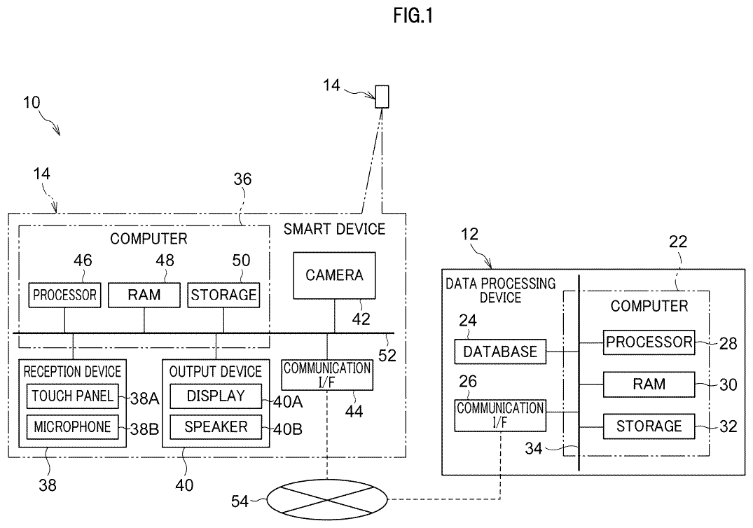

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

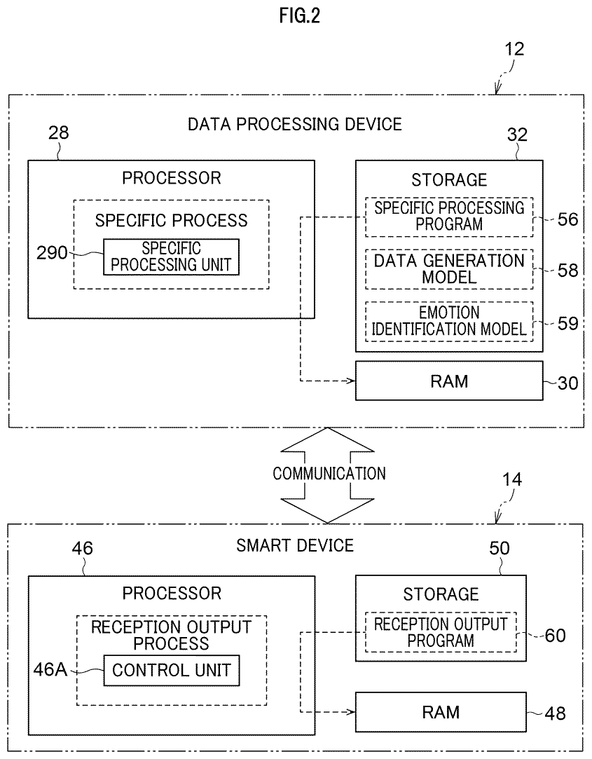

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional security management techniques typically rely on static rule sets, manually curated signatures, and ad hoc updates that are generated in response to already known threats. In such approaches, the core computational processes for collecting threat information, generating attack patterns, designing countermeasures, and evaluating their effectiveness are fragmented, heavily dependent on human expertise, and slow to adapt. As a result, computer systems and networks are often exposed to newly emerging or rapidly evolving attacks for extended periods before effective defenses are deployed.

In addition, known systems that attempt to automate parts of the security lifecycle generally perform limited data processing: they may ingest logs or known indicators of compromise, but they do not systematically integrate large-scale unstructured text data from heterogeneous information sources with advanced natural language processing and machine learning. They also do not fully exploit generative models that can synthesize plausible new attack patterns and corresponding defenses based on high-level contextual prompts. Consequently, these systems cannot proactively propose countermeasures against attacks that have not yet been explicitly documented, and they cannot iteratively refine defenses based on structured simulation feedback in an automated manner.

Furthermore, existing security tools that use machine learning often operate as isolated components focused on a single stage, such as anomaly detection in network traffic. They do not provide an integrated computational framework in which a processor continuously: (i) collects and normalizes multi-source security-related data, (ii) extracts insights via natural language processing and clustering, (iii) generates structured attack patterns through interaction with a generative AI model using explicit prompt sentences, (iv) automatically derives detection rules, communication control settings, and program corrections, (v) simulates attacks in a virtual environment to evaluate these defenses, and (vi) feeds the evaluation results back into the generative process to iteratively optimize the defenses and deploy them to terminal devices. This lack of integration limits the ability of computer systems to self-adapt and improve their defensive posture over time.

Therefore, there is a need for an improved computer-based technique that enhances the functioning of security processing systems themselves, by automating and integrating the end-to-end lifecycle from data collection and analysis, through attack pattern synthesis and defense development, to simulation-based evaluation and feedback-driven optimization, using a processor configured to cooperate with a generative AI model via structured prompt sentences. Such an improvement should reduce manual engineering overhead, shorten the response time to new threats, and increase the robustness and adaptability of the overall security system.

The specific processing by the specific processing unit 290 of the data processing device 12 in Example 1 is realized by the following means.

The present invention provides a server comprising a processor configured to collect security-related data from external and internal information sources by executing data acquisition and normalization processes, to analyze the collected data by applying natural language processing and machine learning in order to classify and cluster attack methods and detect trends and anomalies, to generate attack patterns by supplying a prompt sentence including contextual information derived from the analysis to a generative AI model and receiving, from the generative AI model, structured attack pattern data including at least a precondition, a vulnerability type, a procedure, a payload example, and an observation indicator, to develop defense measures by analyzing features contained in the generated attack patterns and automatically generating at least one of intrusion detection rules, communication control settings, and program modification content, to evaluate the defense measures by constructing a virtual environment, executing simulated attacks based on the generated attack patterns, collecting evaluation results, and analyzing the evaluation results, to perform feedback processing by generating a prompt sentence that incorporates the attack patterns, the candidate defense measures, and the evaluation results, by inputting the prompt sentence to the generative AI model, and by receiving, from the generative AI model, improved defense proposals for iterative optimization of the defense measures, and to distribute the optimized defense measures to a terminal device and cause the terminal device to apply the distributed defense measures. This enables an integrated computer-implemented security lifecycle in which the functioning of the security system is improved by automated and adaptive processing that proactively generates and refines attack patterns and defenses in cooperation with a generative AI model, thereby reducing reliance on manual rule engineering, shortening response time to emerging threats, and enhancing the overall effectiveness and adaptability of computer-based security protection.

The term “processor” refers to a hardware or virtual computing element, such as a central processing unit, a microprocessor, or an execution core of a virtual machine, that executes instructions to perform data processing operations specified by software.

The term “system” refers to a combination of one or more computing devices, storage resources, communication resources, and software components that cooperate to execute the functions described in the claims.

The term “security-related data” refers to information relevant to the identification, characterization, or mitigation of threats and vulnerabilities in information systems, including but not limited to security reports, vulnerability descriptions, incident logs, configuration data, and research publications.

The term “external information source” refers to an information-providing entity or service that is accessible over a communication network and is outside the administrative domain of the system, such as a public database, a public website, or an external log feed.

The term “internal information source” refers to an information-providing entity or service under the administrative control of the system owner, such as an internal log repository, an internal configuration database, or an internal incident tracking system.

The term “data acquisition and normalization process” refers to a sequence of operations in which raw data is obtained from information sources, converted into a standardized format, and preprocessed to remove noise or inconsistencies for subsequent analysis.

The term “structured record” refers to a data structure that stores information in organized fields, such as attribute-value pairs, that facilitate querying, indexing, and further processing by software components.

The term “natural language processing” refers to computational techniques for analyzing and processing human language text or speech, including tokenization, parsing, entity recognition, classification, and semantic analysis.

The term “machine learning” refers to computational methods that infer patterns or models from example data to perform tasks such as classification, clustering, prediction, or anomaly detection without being explicitly programmed for each specific case.

The term “classifying” refers to assigning input data to one or more predefined categories or labels based on learned or predefined criteria.

The term “clustering” refers to grouping input data into sets or clusters such that data within the same cluster is more similar to each other than to data in other clusters, without requiring predefined category labels.

The term “trend” refers to a statistically significant pattern or directional change in security-related data over time, such as an increase in a particular type of attack or vulnerability.

The term “anomaly” refers to an observation or pattern in the data that deviates significantly from expected or typical behavior and may indicate a novel or rare security event.

The term “attack method” refers to a technique, procedure, or sequence of actions used by an attacker to exploit a vulnerability or to compromise an information system.

The term “attack pattern” refers to a structured representation of an attack method, including preconditions, exploited vulnerabilities, steps of the attack procedure, payloads, and observable indicators.

The term “prompt sentence” refers to textual input provided to a generative AI model that specifies context, constraints, or instructions, and that guides the model's generation of output relevant to security analysis or defense design.

The term “generative AI model” refers to a trained computational model that produces text or other data outputs based on input prompts, and that has been trained, for example, using large-scale datasets and machine learning techniques to generate plausible content consistent with the input context.

The term “contextual information” refers to information describing the circumstances, categories, or relationships surrounding data, such as classifications, cluster identifiers, time windows, or environmental attributes, which is used to inform or condition the behavior of a generative AI model.

The term “precondition” refers to a state or set of conditions that must exist in a target system or environment before an attack pattern can be successfully executed.

The term “vulnerability type” refers to a classification of a security weakness, such as input validation flaw, authentication flaw, or configuration error, that can be exploited by an attack.

The term “procedure” refers to a sequence of steps or actions that define how an attack is carried out from initial access to final impact.

The term “payload example” refers to an instance of data, code, or protocol content used during an attack procedure to trigger a vulnerability or produce an unauthorized effect.

The term “observation indicator” refers to a measurable or detectable signal, such as a log entry, network packet characteristic, or system state change, that can be used to infer that an attack pattern is being attempted or has occurred.

The term “defense measure” refers to a configuration, rule, software modification, or operational step intended to prevent, detect, or mitigate an attack.

The term “intrusion detection rule” refers to a machine-readable condition or pattern definition used by an intrusion detection mechanism to recognize suspicious or malicious activity.

The term “communication control setting” refers to a configuration that governs the handling of network or inter-process communications, such as filtering, blocking, rate-limiting, or prioritization rules.

The term “program modification content” refers to information specifying changes to executable code or configuration, including patches, code replacements, or parameter adjustments, that are intended to correct or mitigate a vulnerability.

The term “virtual environment” refers to a simulated or emulated computing environment, implemented using virtualization or container technologies, in which software components and network topologies are instantiated for testing or evaluation.

The term “simulated attack” refers to an execution of an attack pattern in a controlled environment for the purpose of testing or evaluating defenses without causing real-world harm to production systems.

The term “evaluation result” refers to data and metrics derived from observing the behavior of defense measures under simulated attacks, including detection outcomes, performance measurements, and failure cases.

The term “feedback processing” refers to a sequence of operations that use evaluation results to adjust or refine defense measures, including the generation of new prompts and the acquisition of improved proposals from a generative AI model.

The term “improved defense proposal” refers to information output by a generative AI model that specifies modifications or alternatives to existing defense measures in order to enhance their effectiveness or reduce undesirable effects.

The term “iterative optimization” refers to a process in which defense measures are repeatedly revised and tested based on successive cycles of evaluation and feedback.

The term “terminal device” refers to an end-point computing device, such as a client computer, a mobile device, or an embedded device, that receives and applies defense measures distributed from the server.

The term “distribute” refers to transmitting or making defense measures available from a server to one or more terminal devices over a communication network.

The term “apply the distributed defense measures” refers to activating or enforcing the received defense measures on a terminal device by updating configurations, loading rules, or installing program modifications.

In one embodiment, a server hosts the core components of the system, and a terminal operates as an endpoint on which defense measures are enforced. A user interacts with the system through a management interface provided by the server. The server comprises at least one processor, a main memory, a non-volatile storage device, and a network interface. The terminal comprises a processor, a memory, a local storage device, and an operating system that exposes firewall and configuration application programming interfaces.

The server executes system software such as a server-class operating system (for example, a general-purpose operating system), a relational database management system (for example, a general-purpose relational database), a container runtime (for example, a container execution environment), and a network stack supporting secure communication protocols. The server also executes application-level software modules that implement the collection, analysis, attack pattern generation, defense development, simulation, and feedback functions described in the claims. The terminal executes a security agent application that communicates with the server, receives defense packages, and applies local defenses through system interfaces. The server stores collected security-related data and generated artifacts in structured data stores. The server uses a relational database to store normalized text records, categorized attack methods, and defense rules, and uses a document or search index store to maintain full-text searchable documents and embeddings. The server employs an object storage or file system repository for raw documents such as log files, reports, and other artifacts. The server associates each stored item with metadata, including source identifiers, timestamps, feature vectors, and evaluation results, in order to enable efficient querying and correlation.

The server implements natural language processing using a framework such as a tokenization and parsing library and a model execution engine for contextual embeddings. The server converts unstructured text into a sequence of tokens, assigns part-of-speech tags, identifies named entities such as software products, protocol names, and vulnerability identifiers, and computes dense vector representations using a transformer-based model. The server uses a machine learning framework such as a tensor-based computation library to train and execute classification and clustering models. The server represents each document or event as a feature vector, comprising, for example, token frequencies, contextual embedding coordinates, and metadata-derived numerical features such as timestamp bucketing and severity scores.

The server implements a generative AI model as a neural network comprising multiple layers. In one embodiment, the generative AI model is a transformer-based language model having an embedding layer, a plurality of attention blocks, and an output projection layer. The server stores model parameters, such as weight matrices and bias vectors, on a storage device, and loads these parameters into memory when executing inference. The server represents an input prompt sentence as a token sequence, converts the sequence into embeddings, processes the embeddings through self-attention mechanisms that compute attention scores using learned query, key, and value projections, and computes an output token distribution via a softmax function. The server samples or decodes from the output distribution to generate new tokens, concatenating them to form an output text sequence. The server may apply beam search or top-k sampling to control diversity and quality of generation.

The server uses specific prompt sentence formats to instruct the generative AI model. For example, the server generates a prompt sentence such as:

“Based on the following recent vulnerability descriptions and attack clusters, generate new attack patterns. For each attack pattern, specify: (1) preconditions, (2) vulnerability type, (3) step-by-step procedure, (4) example payloads, and (5) network and log indicators.”

The server concatenates this instruction with context text that includes summarized vulnerability information and clustering results. The server encodes this combined text as input tokens to the generative AI model. The structure of the prompt sentence, including explicit field labels and ordering, causes the generative AI model to output attack pattern descriptions in a semi-structured format, which the server can subsequently parse by detecting the labels and delimiters.

The server also uses a prompt sentence format to request defense proposals. For example, the server generates a prompt sentence such as:

“Given the following attack patterns and sample vulnerable code fragments, design specific defenses: (1) intrusion detection rules, (2) communication control rules, and (3) secure code modifications. Explain how each defense addresses the corresponding attack.”

The server appends selected attack pattern records and code snippets to this prompt sentence. The generative AI model, conditioned on this input, outputs suggested rules and code modifications in a consistent textual layout. The server parses the output by recognizing rule markers, such as line prefixes or section headings, and converts the text into machine-readable rule objects and patch descriptors.

The server employs specific training and fine-tuning procedures to adapt the generative AI model to the security domain. In one embodiment, the server collects a training corpus comprising historical vulnerability descriptions, attack writeups, defense guidelines, and rule sets. The server encodes this corpus as input-output pairs, where the input comprises a prompt-like description of a situation, and the output comprises the desired structured response (e.g., an attack pattern or a rule set). The server trains the generative AI model using a supervised learning method that minimizes a cross-entropy loss function between predicted token distributions and ground truth tokens, using gradient-based optimizers such as an adaptive learning rate method. The server applies backpropagation through time over the transformer layers to update the weights. The server may further use regularization techniques such as dropout on attention heads and layer normalization to stabilize training. The server thereby obtains a model that is specialized for generating attack and defense content given structured prompt sentences.

The server uses anomaly detection models to identify outlier attack techniques and to prioritize them for pattern generation. The server constructs a feature space in which each document or pattern is represented by a high-dimensional vector. The server applies an algorithm such as isolation-based anomaly detection, which randomly selects features and split values to partition data points and measures path lengths for data points through the resulting trees. The server identifies data points with shorter average path lengths as anomalies. The server passes these anomalies as emphasized context to the generative AI model, thereby biasing the generation process towards novel techniques that deviate from known patterns. This targeted approach improves the technical effect of early detection of emerging threats.

The server constructs simulation environments using virtualization or containerization. The server uses a hypervisor or container executor to instantiate virtual machines or containers representing servers, clients, and network devices. The server configures virtual network topologies, including routing paths, latency characteristics, and bandwidth constraints, using virtual networking constructs. The server deploys actual implementations of intrusion detection engines and firewall modules into these virtual nodes. By running realistic instances of security software on virtual hardware, the server can directly measure resource consumption, latency, and detection events, which are technical properties of the computer system.

The server synthesizes traffic for simulated attacks by producing network packets and application-layer protocols corresponding to the generated attack patterns. The server generates packet sequences using a packet construction library, setting fields such as source and destination addresses, protocol numbers, flags, and payload bytes according to the attack procedure. The server schedules and sends these packets through the virtual network. The server captures resulting traffic using packet capture utilities and stores capture files. Because the server drives actual packet-level traffic through a protocol stack, the evaluation results directly reflect the behavior of operating system kernels, network card drivers, and security modules, rather than abstract symbolic outcomes.

The server aggregates evaluation metrics in structured data records. For each defense rule and each attack pattern, the server records metrics including detection count, false positive count, processing latency, packet drop rate, and CPU and memory usage on relevant nodes. The server computes derived values such as detection rate, precision, recall, and overhead ratios. The server uses these metrics as input features to a secondary analysis module that ranks defenses by effectiveness and resource impact.

The server uses the generative AI model in combination with these metrics to refine defenses beyond simple threshold adjustments. For example, the server constructs a prompt sentence such as:

“Using the following detection statistics and performance metrics for each rule, propose improved intrusion detection and communication control rules that reduce false positives while preserving detection of high-severity attacks. Explain the changes and their expected impact.”

The server includes tabular or textual summaries of rule-level metrics after the instruction. The generative AI model, conditioned on this mixture of natural language and structured information, proposes rule modifications, such as tightening pattern matches for low-confidence fields or splitting a broad rule into multiple narrower rules based on different attack subtypes. The server then parses these modifications and applies additional static analysis: for example, verifying that their syntactic form is valid, checking for overlaps or conflicts with existing rules, and simulating their effect on cached traffic traces.

The server therefore does not merely replace human editors; instead, the server implements a closed-loop optimization process that repeatedly uses machine-generated proposals, combined with quantitative simulation results, to improve a set of executable configurations. The server applies evaluation metrics as objective functions, and the generative AI model as a flexible generator constrained by structured prompt sentences. This non-conventional workflow exploits computer-specific capabilities—high-volume simulation, rapid rule generation, and complex pattern analysis—to achieve defense configurations that human operators would not feasibly derive by manual editing alone. As a result, the server improves the technical performance of the security system, measured by increased detection accuracy and reduced computational overhead.

The terminal applies received defense measures in a way that concretely alters system behavior. The terminal writes firewall rules to kernel-managed tables using system calls or operating-system APIs. The terminal loads intrusion detection rules into a local detection engine that monitors network packets. The terminal applies program modifications by installing updated executable components or configuration files. The terminal monitors network connections and process behavior in real time, comparing them to the received detection and control rules. When the terminal identifies a match, the terminal blocks packets, terminates processes, or raises alerts according to the rule definitions. Because these actions take place within the protocol stacks and process schedulers of the terminal, the defense measures directly control the operation of computing hardware and system resources. The user interacts with the server to adjust high-level objectives that shape the optimization process. The user may specify, through an interface, target ranges for acceptable false positive rates, maximum allowed latency overhead, or priorities for protecting specific services. The server encodes these user-defined constraints as additional parameters in the prompt sentences, for example:

“Optimize the following rule set to keep the false positive rate below 1% and the average latency overhead below 5%, while maximizing detection of remote code execution attacks.” The server includes numerical targets and current statistics in the prompt. The generative AI model generates proposals that reflect the trade-offs expressed in the text, and the server evaluates these proposals quantitatively. In this manner, the user steers the system at a high level, while the server performs detailed technical optimizations that require large-scale computation.

In another embodiment, the server deploys multiple variants of the generative AI model, each fine-tuned for a particular subtask, such as attack pattern synthesis, code patching, or rule optimization. The server selects which model to invoke based on the type of prompt sentence and the required output structure. The server maintains model selection metadata and uses a routing component to dispatch requests to the appropriate model instance. This modular arrangement allows the server to optimize each model's architecture and hyperparameters for its respective task; for example, a model generating short code patches may use a different maximum context length and vocabulary distribution than a model generating long-form attack descriptions.

In yet another embodiment, the server augments the feature set used by classification and clustering models with hardware-dependent signals, such as sensor logs or low-level performance counters from protected systems. The server includes these signals in the embedding vectors and uses them as additional dimensions in clustering and anomaly detection. This integration allows the server to discover correlations between high-level textual vulnerability descriptions and low-level runtime behavior. As a result, the server can generate attack patterns and defenses that are tuned not only to software semantics but also to specific hardware and platform characteristics, further improving detection precision and efficiency.

Through the above configurations, the server, terminal, and user cooperate to implement the claimed system. The server executes concrete, structured data transformations using defined hardware and software components; the generative AI model operates within a constrained framework driven by explicit prompt sentences and quantifiable objectives; and the terminal applies the resulting defenses directly at the hardware and operating-system level. This integrated design provides a specific, technical improvement to computer security systems, including faster adaptation to new threats, more precise rule sets with reduced false positives, more efficient use of processing and network resources, and a scalable mechanism for continuously optimizing defenses in response to changing conditions.

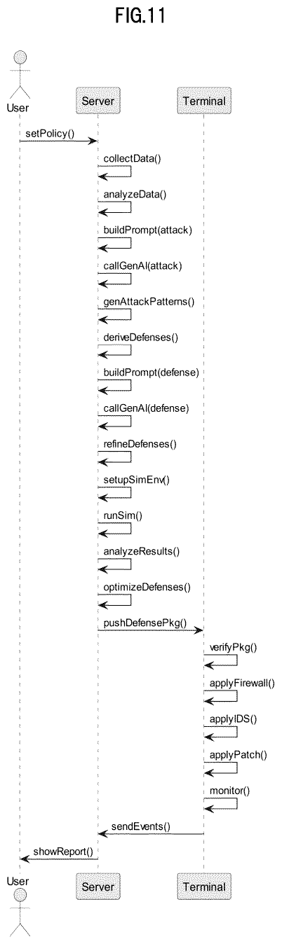

The following describes the processing flow using FIG. 11.

### Step 1:

Server acquires and normalizes security-related data.

Server receives, as input, raw data from external information sources and internal information sources, including documents such as security reports, vulnerability advisories, technical articles, and incident logs. Server sends HTTP or API requests, downloads files, and parses formats such as HTML, PDF, and plain text using parsing software. Server performs data operations including tokenization, language detection, character encoding normalization, and removal of non-informative content. Server converts the raw input into structured records containing fields such as source identifier, timestamp, text body, and basic tags, and stores these structured records in a database as the output of this step.

### Step 2:

Server analyzes collected data and extracts feature representations.

Server takes, as input, the structured records stored in the database. Server applies natural language processing operations to the text body fields to identify tokens, part-of-speech tags, named entities, and dependency relations. Server then computes numerical feature vectors using methods such as term frequency-inverse document frequency and contextual embeddings generated by a neural language model. Server also attaches metadata-derived features, such as severity scores or frequency counts, to each record. Server outputs, for each input record, a combined feature vector and associated labels that are stored in an analysis store.

### Step 3:

Server classifies and clusters attack-related records.

Server uses, as input, the feature vectors from the analysis store. Server applies machine learning algorithms, such as supervised classifiers and clustering algorithms, to assign each record to one or more attack categories and to group similar records into clusters. Server performs data operations including distance computation in feature space, centroid updates, and cluster assignment decisions. Server outputs a set of classified records and cluster identifiers, and stores mapping data that associates each record with an attack category and a cluster.

### Step 4:

Server identifies anomalies and emerging attack trends.

Server receives, as input, the classified and clustered records along with temporal metadata. Server applies anomaly detection algorithms to the feature vectors and cluster statistics, computing measures such as anomaly scores and deviation from baseline patterns. Server also performs time-series analysis by aggregating counts of attack categories over defined time windows and calculating trend indicators. Based on these computations, server outputs a list of anomalous records and trend summaries that highlight potentially emerging attack techniques.

### Step 5:

Server prepares contextual information and constructs a prompt sentence for attack pattern generation.

Server takes, as input, the cluster definitions, anomaly highlights, and representative records. Server selects representative samples from each important cluster, extracts key attributes such as vulnerability type, affected platform, and known payload characteristics, and composes a textual context summary. Using this summarized context, server generates a prompt sentence that instructs a generative AI model to propose new attack patterns, for example:

“Based on the following recent vulnerabilities and attack clusters, generate new attack patterns. For each attack pattern, specify: (1) preconditions, (2) vulnerability type, (3) step-by-step procedure, (4) example payloads, and (5) network and log indicators.”

Server concatenates the context summary and the prompt sentence into a single input string and outputs this combined text for use in the next step.

### Step 6:

Server invokes the generative AI model to generate attack patterns.

Server receives, as input, the combined prompt sentence and context text. Server converts the text into tokens, feeds the token sequence into the generative AI model, and executes neural network inference operations including embedding lookup, attention computation, and output probability calculation. Server decodes the output token sequence into human-readable text that describes multiple attack patterns. Server parses the generated text by detecting segment delimiters and field labels, and transforms the text into structured attack pattern records containing fields such as preconditions, vulnerability types, procedures, payload examples, and observation indicators. Server outputs these structured attack pattern records and stores them in an attack pattern repository.

### Step 7:

Server derives initial defense measures from generated attack patterns.

Server uses, as input, the structured attack pattern records from the repository. Server extracts characteristic elements such as suspicious parameter names, URL paths, protocol flags, and log signatures. Server performs data operations including pattern extraction, regular expression construction, and rule template filling to convert these elements into defense artifacts. Server produces, as output, initial intrusion detection rules, communication control settings, and program modification suggestions in a machine-readable format, and stores them in a defense measure repository.

### Step 8:

Server constructs a prompt sentence for defense design refinement.

Server takes, as input, the attack pattern records and the initial defense measures. Server generates a textual summary that pairs each attack pattern with its corresponding initial defense. Server then constructs a prompt sentence that requests refined and optimized defenses, for example:

“Given the following attack patterns and initial defenses, refine the intrusion detection rules, communication control rules, and secure code modifications so that they block the attacks while minimizing false positives.”

Server concatenates the summary and the prompt sentence into a combined input string and outputs this text to be supplied to the generative AI model.

### Step 9:

Server refines defense measures using the generative AI model.

Server receives, as input, the combined defense refinement prompt and summary. Server encodes this text as tokens and executes generative inference using the generative AI model. Server obtains an output text that proposes adjusted intrusion detection rules, communication control configurations, and program modifications, often including explanations. Server parses the output text, extracts the revised rule definitions and code change instructions, and converts them into structured defense configurations. Server outputs updated defense measures, which replace or extend the initial defense measures in the defense measure repository.

### Step 10:

Server constructs a virtual environment for evaluation of defense measures.

Server uses, as input, the current defense measures and a description of target system configurations. Server allocates computing resources to instantiate virtual machines or containers, configures virtual networks with specific topologies and parameters, and deploys sample applications and services. Server installs intrusion detection engines and firewall components into the virtual nodes and loads the defense measures as active configurations. Server outputs a fully configured virtual environment ready for attack simulations.

### Step 11:

Server executes simulated attacks and collects evaluation data.

Server receives, as input, the virtual environment and the structured attack pattern records. Server generates attack traffic by constructing packets and protocol messages according to the procedures and payload examples specified in the attack patterns. Server sends this traffic through the virtual network towards target nodes while monitoring system logs, detection alerts, and performance metrics. Server records, as output, evaluation data comprising for each attack and each defense measure a set of metrics such as detection outcomes, false positives, processing latency, and resource utilization. Server stores this evaluation data in an evaluation repository.

### Step 12:

Server analyzes evaluation data and derives feedback information.

Server takes, as input, the evaluation data associated with the executed simulations. Server performs data operations including aggregation of metrics per rule and per attack pattern, computation of detection rates, false positive rates, and overhead ratios, and identification of underperforming or overly strict rules. Server generates feedback information that associates each defense measure with its measured performance indicators and with recommended adjustment directions. Server outputs this feedback information as structured records and textual summaries.

### Step 13:

Server prepares a prompt sentence for feedback-driven optimization.

Server uses, as input, the feedback information, the current defense measures, and optionally user-specified constraints such as acceptable false positive thresholds. Server composes a textual description of the key evaluation results and constraints and constructs a prompt sentence such as:

“Using the following evaluation results and constraints, propose improved intrusion detection and communication control rules and refined code modifications that reduce false positives while maintaining high detection of severe attacks.”

Server combines this description and the prompt sentence into a single text and outputs it for use by the generative AI model.

### Step 14:

Server performs iterative optimization of defense measures using the generative AI model.

Server receives, as input, the optimization prompt and feedback description. Server encodes this input, runs generative inference, and obtains output text that includes revised rules and configuration changes tailored to the provided metrics and constraints. Server parses the text into structured defense configurations, compares the revised measures with previous versions, and resolves conflicts or redundancies. Server outputs a new version of the defense measures, and may repeat Steps 10 through 14 until evaluation metrics meet predefined targets.

### Step 15:

Server packages and distributes defense measures to terminals.

Server uses, as input, the finalized defense measures and a list of target terminal identifiers. Server creates defense packages that include intrusion detection rules, communication control settings, and program modification instructions, and signs these packages digitally. Server transmits the packages over a secure communication channel to terminals, tracking which terminals have successfully received and acknowledged each package. Server outputs distribution status records that indicate deployment coverage and any errors encountered.

### Step 16:

Terminal retrieves and verifies defense packages.

Terminal receives, as input, notifications from the server or periodic polling results that indicate availability of new defense packages. Terminal downloads the packages via a secure protocol and verifies digital signatures or integrity checksums. Based on successful verification, terminal extracts the contents of the defense packages. Terminal outputs verified configuration files, rule sets, and patch instructions to its local security agent module.

### Step 17:

Terminal applies defense measures to system components.

Terminal uses, as input, the verified defense content. Terminal calls operating system interfaces to update firewall rules, loads intrusion detection rules into a local detection engine, and applies program modifications by updating executable files or configuration parameters. Terminal performs data operations such as rewriting configuration tables, reloading security services, and adjusting runtime parameters. Terminal outputs a modified system state in which new defenses are actively enforced at the network and application layers.

### Step 18:

Terminal monitors runtime behavior and reports security events.

Terminal takes, as input, live network traffic, process activity, and system logs. Terminal compares these inputs against the applied detection rules and communication control settings, evaluates matching conditions, and triggers actions such as blocking connections or generating alerts when rules are satisfied. Terminal aggregates detected events and relevant telemetry data into event records. Terminal outputs these event records and periodically transmits them back to the server for further analysis and possible inclusion in subsequent optimization cycles.

### Step 19:

User configures policy objectives and reviews system behavior.

User receives, as input, reports and dashboards generated by the server based on evaluation data and runtime events. User specifies high-level objectives such as desired security level, acceptable false positive rates, and performance constraints through a management interface. User may also request targeted analyses or simulations for specific systems or applications. Server treats these user inputs as additional parameters or constraints, incorporates them into future prompt sentences for the generative AI model, and outputs updated optimization goals that influence subsequent processing steps.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional network security systems that employ anomaly detection and rule-based defenses typically rely on statically designed data schemas, hand-crafted feature sets, manually tuned thresholds, and manually authored defense rules. In such systems, the logic for log collection, feature extraction, model training, anomaly detection, and defense rule generation is implemented as fixed program code. As the scale, topology, and traffic characteristics of computer networks evolve, and as attack techniques become more sophisticated and diverse, these static configurations become suboptimal. As a result, the systems suffer from degraded detection accuracy, increased false positives and false negatives, slow adaptation to new attack patterns, and an increased operation cost for human experts who must repeatedly redesign collection policies, feature sets, models, and defense rules.

Moreover, when a generative AI model is used in a naive manner merely to summarize events or generate human-readable descriptions, the generative AI model does not directly improve the core computer-implemented pipeline of data collection, feature computation, model configuration, threshold setting, or automatic defense control. In other words, existing uses of generative AI models are often limited to peripheral assistance functions and do not provide a systematic mechanism by which a processor can incorporate AI-generated configuration information back into the executable control flow of a network defense system in a closed-loop manner. Consequently, the underlying computer technology—specifically, the architecture and operation of the anomaly detection and defense automation pipeline—remains manually engineered, brittle, and difficult to maintain.

There is therefore a need for an improved computer-implemented system in which a processor interacts with a generative AI model through explicit prompt sentences and input sentences, obtains structured output information that defines log collection configurations, feature definitions, learning methods, anomaly thresholds, and defense control information, and automatically applies the output information to dynamically reconfigure the data collection, analysis, detection, and defense components. Such a system should further record detection results, defense results, and user determinations as history information, and repeatedly feed summarized history information back to the generative AI model, so that the processor can automatically refine decision rules, feature sets, and execution conditions for defense actions. By embedding the generative AI model into the configuration and control loop of the anomaly detection and defense pipeline, the goal is to improve the operation of the computer system itself, including adaptability, detection performance, and efficiency of automated defense, while reducing the manual engineering burden.

The specific processing by the specific processing unit 290 of the data processing device 12 in Application Example 1 is realized by the following means.

The present invention provides a server comprising a processor configured to obtain and analyze information, generate attack behaviors, generate defense behaviors, acquire and record communication information, analyze the communication information and generate feature values, generate, by a learning process, decision rules representing normal behaviors, evaluate the communication information using the generated decision rules and detect abnormal behaviors, update control information of a communication control apparatus on the basis of the detected abnormal behaviors, record and evaluate results of the defense behaviors, and transmit an input sentence including a prompt sentence to a generative information processing apparatus, obtain output information generated by the generative information processing apparatus based on the input sentence, and use the output information to constitute at least a part of generation of the attack behaviors, generation of the defense behaviors, generation of the feature values, and generation of the decision rules. This enables the computer-implemented security pipeline itself to be dynamically configured and optimized by the generative information processing apparatus through structured prompt-based interaction, thereby improving the adaptability, detection accuracy, and automatic defense performance of the underlying computing system while reducing manual configuration effort.

The term “processor” refers to a hardware information processing unit, such as a central processing unit or other execution circuitry, which executes program instructions to perform the functions described in the claims.

The term “system” refers to a combination of at least one processor and one or more memory devices, communication interfaces, and control components that cooperate to implement the claimed functions.

The term “generative information processing apparatus” refers to an information processing system, such as a generative AI model or generative machine learning model executed on one or more processors, which receives an input sentence including a prompt sentence and generates, based on the input sentence, output information including configuration information, rules, or other structured data.

The term “input sentence” refers to electronic text data supplied to the generative information processing apparatus, the text data including at least one prompt sentence and optionally additional context or parameter information.

The term “prompt sentence” refers to a portion of the input sentence that explicitly instructs the generative information processing apparatus to perform a specified generation task, such as generation of configuration information, feature definitions, decision rules, or defense behaviors.

The term “output information” refers to data generated by the generative information processing apparatus in response to the input sentence, the data including at least one of configuration information, parameter information, decision rules, feature definitions, threshold values, or control information usable by the processor.

The term “communication information” refers to data representing communication in an information communication network, including at least one of packet-level information, flow-level information, session-level information, address information, port information, protocol information, data amount information, and time information.

The term “communication control apparatus” refers to a network control component that controls communication in an information communication network, including at least one of a firewall apparatus, an intrusion prevention apparatus, a gateway apparatus, a router apparatus, or a switch apparatus.

The term “control information” refers to information used to control the operation of the communication control apparatus, including at least one of filter rules, access control rules, routing rules, rate control parameters, and blocking or allowing conditions for network traffic.

The term “feature values” refers to numerical or categorical values derived from the communication information, which represent characteristics or statistics of the communication information and are used as input to a learning process or an anomaly detection process.

The term “learning process” refers to a computational process in which the processor applies a machine learning algorithm to training data including the feature values, to generate or update decision rules, parameters, or models representing at least normal behaviors or abnormal behaviors.

The term “decision rules” refers to information defining criteria for evaluating communication information, including at least one of trained model parameters, classification conditions, anomaly score thresholds, and rule sets used to determine whether behaviors are normal or abnormal.

The term “normal behaviors” refers to patterns of communication information that are determined, by the learning process or by prior configuration, to correspond to expected or legitimate operation of the information communication network.

The term “abnormal behaviors” refers to patterns of communication information that deviate from the normal behaviors according to the decision rules, and that may indicate at least one of attacks, intrusions, misconfigurations, or failures in the information communication network.

The term “attack behaviors” refers to modeled or generated representations of potential harmful operations against the information communication network or computing resources, including at least one of simulated attack scenarios, attack patterns, or adversarial traffic definitions.

The term “defense behaviors” refers to actions or procedures for protecting the information communication network or computing resources, including at least one of modifying control information of the communication control apparatus, blocking or limiting network traffic, or changing system configurations to mitigate abnormal behaviors.

The term “history information” refers to stored information including at least detection results of abnormal behaviors, evaluation results of defense behaviors, user determination results regarding incidents, and associated time information, which is used for subsequent analysis and configuration updates.

The term “summary information” refers to information derived from the history information, including aggregated or compressed representations of past detection results, defense performance, and user determinations, which is transmitted as part of the input sentence to the generative information processing apparatus.

The term “threshold update information” refers to information included in the output information from the generative information processing apparatus that specifies new or modified threshold values for decision rules or anomaly detection criteria.

The term “automatic execution conditions” refers to conditions defined by information included in the output information from the generative information processing apparatus, the conditions specifying when defense behaviors are to be executed automatically without further user confirmation.

In an embodiment, a server executes a program that implements the system according to the above claims. The server includes at least one processor, a memory, and one or more network interfaces connected to an information communication network and to a communication control apparatus. The server stores executable instructions in the memory, and the processor executes the instructions to perform functions including acquisition and recording of communication information, analysis of the communication information, generation and application of decision rules, interaction with a generative AI model by way of an input sentence including a prompt sentence, and automatic update of control information applied to the communication control apparatus.

The server uses hardware such as a general-purpose computing device with a central processing unit, an optional graphics processing unit or tensor processing unit for machine learning, and network adapters supporting packet capture. The server executes system software such as an operating system, and application software such as a packet capture component, a data storage component, and a machine learning component. In one example, the server uses a packet capture library to obtain network packets from a mirror port of a network switch, uses a relational database or a document database as the data storage component, and uses a numerical computation library and a machine learning library as the machine learning component. The server communicates with the generative AI model through an application programming interface.

The server acquires communication information from a network device such as a router, a switch, or a gateway that forwards communication packets between computing devices. The server receives packet-level data or flow-level data via interfaces such as port mirroring or flow export. The server parses headers of packets or flow records to derive values such as source address, destination address, source port, destination port, protocol identifier, packet count, byte count, and timestamps. The server stores these values in a structured data store as records having fields for the above items, for example as rows in a table or documents in an index.

The server analyzes the stored communication information and generates feature values that summarize characteristics of communication for specific time intervals and network entities. The server groups communication records by keys such as source address and destination address for each fixed-length time window, and computes feature values such as total bytes, total packets, number of distinct destination ports, ratio of failed connections, and entropy of destination ports. The server represents each group as a feature vector in a multidimensional numerical space. The server stores these feature vectors in association with corresponding time windows and network entities.

The server performs a learning process to generate decision rules representing normal behaviors. The server selects a training dataset of feature vectors taken from a period considered to represent stable and legitimate operation. The server inputs the feature vectors to a machine learning algorithm such as an isolation forest, a one-class classification algorithm, or an autoencoder neural network. In an embodiment, the server uses an autoencoder having an input layer whose dimension matches the number of feature values, one or more hidden layers with fewer units than the input layer, and an output layer having the same dimension as the input layer. The server trains the autoencoder using an objective function such as mean squared error between input and output, and updates parameters of the autoencoder by gradient-based optimization. By minimizing reconstruction error on normal traffic, the server obtains a model that encodes patterns of normal behaviors in compressed internal representations.

In another embodiment, the server uses an isolation forest algorithm that constructs a plurality of decision trees by randomly selecting features and split points. The server computes path lengths for each training sample and derives an anomaly score for each sample. Based on a target contamination rate describing an expected fraction of anomalies, the server sets a threshold on the anomaly score and designates scores below or above the threshold as normal. The server stores model parameters and thresholds as decision rules that can be applied to new feature vectors.

The server evaluates incoming communication information by applying the generated decision rules to newly computed feature values. When the server uses an autoencoder, the server normalizes input feature vectors with a scaling transformation obtained during training, passes the vectors through the trained network to obtain outputs, computes reconstruction errors, and compares the errors to a threshold. When the error exceeds the threshold, the server classifies the corresponding communication pattern as an abnormal behavior. When the server uses an isolation forest, the server applies the forest to compute an anomaly score and compares the score to a threshold in a similar manner. The server records detection results as history information including time, feature values, anomaly scores, decisions, and identifiers of related network entities.

The server updates control information of the communication control apparatus on the basis of detected abnormal behaviors. The server transforms detection results into control commands such as blocking of specific addresses, limiting of connection rates, or updating of rule sets used by the communication control apparatus. The server transmits the control commands through a control interface of the communication control apparatus, for example by an application programming interface, a command-line interface, or a management protocol. As a result, the communication control apparatus alters its processing of communication packets in real time. This configuration produces a direct control effect on physical packet forwarding and thereby prevents or mitigates undesirable traffic. Because the server derives the control commands from algorithmic evaluation of numerical feature vectors and anomaly scores, the server achieves faster reaction times and finer-grained control than could be achieved by manual human operation.

The server interacts with a generative AI model that functions as a generative information processing apparatus. The server prepares an input sentence including a prompt sentence that describes a desired generation task in natural language, and may add structured examples or context information. The server transmits the input sentence to the generative AI model via a network interface. The generative AI model executes a neural network having a sequence-processing architecture such as a transformer, in which the model encodes tokens of the input sentence into embeddings, processes the embeddings with multiple attention layers and feedforward layers, and decodes output tokens based on learned parameters. The generative AI model uses a probability distribution over vocabulary tokens conditioned on previous tokens and internal states, and selects tokens by sampling or by a search algorithm. The server causes the generative AI model to generate output information that defines or updates technical configurations. In one example, the server transmits the following prompt sentence as part of the input sentence:

“Design a log collection configuration for monitoring network traffic in a data center. Specify which fields to record (such as source IP, destination IP, ports, protocols, byte counts, and timestamps), define the sampling rate for high-volume flows, and propose retention periods for detailed logs and aggregated summaries.”

Upon receipt of the output information from the generative AI model, the server parses the output information and extracts configuration data such as a list of fields, sampling rates, and retention durations. The server applies the configuration data by adjusting data collection modules and storage rules. In another example, the server uses a prompt sentence of the following form:

“Given the current feature definition and traffic description, select an anomaly detection algorithm and hyperparameters, and propose a threshold selection method that balances detection rate and false alarm rate for this environment.”

The server uses the response to adjust algorithm selection and hyperparameters in the machine learning component. Thus, the generative AI model does not merely produce human-readable advice, but instead provides structured configuration information that the server incorporates into programmatically executed control flows, leading to technical modifications in data structures, sampling, model topology, and threshold computation.

The server also uses the generative AI model to generate defense behaviors. For example, the server may construct an input sentence including a prompt sentence such as:

“For the following list of source IP addresses, ports, and anomaly scores that have been classified as attacks, generate specific firewall rules and rate-limiting policies that minimize impact on legitimate traffic, and propose temporary block durations.”

The server then receives output information describing specific actions, maps these actions to parameters and rule elements for the communication control apparatus, and applies the actions. The server may automatically filter out recommendations that conflict with static safe lists or core infrastructure addresses, thereby combining machine-generated proposals with deterministic safety checks.

The server continuously records detection results, applied defense actions, and evaluation results of the defense actions. The server determines evaluation results by measuring, for example, whether traffic volumes associated with abnormal behaviors decrease after a defense action, and whether legitimate traffic experiences errors or delays. The server stores these results and any user-provided classifications as history information. Periodically, the server summarizes the history information and sends an input sentence including a prompt sentence and the summary to the generative AI model. An example prompt sentence is:

“Analyze the past seven days of anomaly detections, defense actions, and user labels. Identify patterns of false positives and missed attacks, and propose updated anomaly score thresholds, new or removed features, and conditions under which automatic blocking should be enabled or disabled.”

The server interprets the output information as threshold update information, feature modification instructions, and changes to automatic execution conditions. The server then updates decision rules and control policies accordingly. This closed-loop arrangement allows the computing system to adapt its internal data schemas, feature sets, learning methods, and control rules to evolving traffic conditions and attack techniques with reduced manual intervention.

The terminal provides a user interface that allows a user to monitor and influence the above processes. The terminal may be a personal computing device, a portable communication device, or a workstation that communicates with the server over a network. The terminal displays dashboards, logs, anomaly lists, model status information, and AI-generated explanations. The server sends structured data to a frontend application running on the terminal. The user views detection results, defense actions, and system configuration summaries. The user can approve or reject specific AI-generated defense behaviors, alter parameters such as sensitivity levels, or manually reclassify incidents as benign or malicious. When the user performs such operations on the terminal, the server receives the input, updates history information, and in some cases triggers retraining or reconfiguration processes. The described configuration improves computer technology in several ways. Because the server uses structured feature vectors, quantitative thresholds, and model-based evaluation rather than static rule lists, the server can process large volumes of communication information with lower latency and higher accuracy than manual inspection or fixed heuristics. By integrating the generative AI model into the configuration path rather than only into a reporting layer, the server can optimize log schemas, feature sets, and model hyperparameters for specific network environments, which reduces data volume without sacrificing detection capability, and improves computational efficiency by focusing on high-value features. The server can, for instance, reduce communication load between sensors and the server by adopting sampling strategies and aggregation schemas generated by the generative AI model. Moreover, because the generative AI model is instructed by prompt sentences to generate configuration objects respecting constraints, and because the server validates and applies these objects programmatically, the system achieves non-conventional adaptation behavior that would be difficult to replicate with hand-coded static logic or simple human-scripted rules.

The server and the generative AI model also employ learning methods and internal criteria that are distinct from typical manual procedures. The machine learning component uses loss functions, such as reconstruction error or anomaly scores derived from tree path lengths, and updates internal parameters according to gradient-based or ensemble-based optimization processes. The generative AI model uses attention-based architectures and token-level probability distributions learned from large-scale training data. As a result, the system explores a wider space of configuration and defense strategies, uncovers correlations among features and system states that may not be apparent to human operators, and refines thresholds and policies in response to empirical performance data.

In another embodiment, the server uses alternative model architectures, such as recurrent neural networks or graph neural networks, to encode temporal dependencies or topological relationships among network entities. The server may also incorporate additional feature values derived from external logs, such as authentication logs or application logs, and extend the learning process to multi-modal data. In a further embodiment, the server may deploy separate generative AI models specialized for log schema design, feature engineering, or defense rule synthesis, and route different categories of prompt sentences to different models. In each case, the server maintains a consistent data flow: communication information is transformed into feature values; feature values are processed by analytical models and decision rules; results are recorded and evaluated; history information is summarized; and the summaries are used in prompt sentences that lead to refined configuration information. This architecture ties the use of the generative AI model directly to technical adjustments of data structures, internal algorithms, and control flows, thereby producing a concrete technical improvement in the operation of the server and the associated communication control apparatus.

The user, by interacting with the terminal, can select among operation modes such as a fully automatic mode, a semi-automatic mode requiring approvals for certain actions, and a monitoring-only mode. The server enforces these modes by enabling or disabling automatic execution of defense behaviors and by changing how results of AI-generated recommendations are applied. In all modes, the server continues to collect detailed history information and to use that information for further learning and reconfiguration. In this way, the system maintains and improves its technical performance over time, including detection precision, recall, response times, and computational resource utilization.

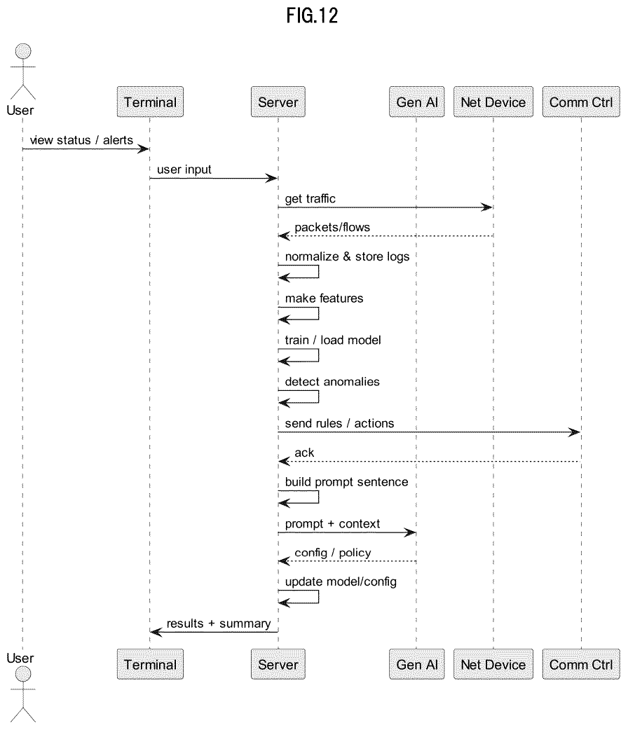

The following describes the processing flow using FIG. 12.

### Step 1:

Server acquires raw communication information from network devices.

Server receives, as input, packet streams or flow records from switches, routers, or gateways via a mirrored port or a flow-export protocol. Server parses headers of the received packets or flow records to extract data items such as source address, destination address, source port, destination port, protocol identifier, packet count, byte count, and timestamps. Server performs data conversion operations including byte-order normalization, timestamp normalization to a standard time zone, and mapping of protocol numbers to protocol types. Server outputs structured raw communication records and writes them into a temporary storage area in memory or a persistent storage device.

### Step 2:

Server normalizes and stores the communication information.

Server reads, as input, the structured raw communication records produced in Step 1. Server performs data processing operations that include removing duplicate records, validating field formats, and enriching records with derived fields such as connection duration or direction flags. Server converts the records into a unified data structure, for example a table-like format with fixed columns or a document format with key-value pairs. Server indexes selected fields for efficient retrieval, such as indexing by source address, destination address, and time. Server outputs normalized communication records and stores them in a data repository for later analysis.

### Step 3:

Server aggregates communication information and generates feature values.

Server receives, as input, the normalized communication records from the data repository within a specified time window. Server groups the records according to aggregation keys such as (source address, destination address, protocol, time window). For each group, server calculates numerical and categorical feature values, including total bytes, total packets, number of distinct destination ports, frequency of connection attempts, ratio of failed connections, and entropy of destination ports. Server performs arithmetic operations such as summation, division, and logarithmic computation, as well as statistical operations such as counting unique values. Server outputs feature vectors that represent each group as a multidimensional array of feature values and stores the feature vectors in a feature storage area.

### Step 4:

Server prepares training data and executes a learning process to generate decision rules.

Server retrieves, as input, a set of feature vectors corresponding to time periods that are designated as normal operation. Server splits the feature vectors into training and validation subsets and applies preprocessing operations such as scaling and normalization across dimensions. Server then inputs the training feature vectors into a machine learning algorithm, such as an autoencoder neural network or an isolation forest. For an autoencoder, server feeds each feature vector through an input layer, one or more hidden layers, and an output layer, calculates reconstruction error as a loss value, and updates internal weights by an optimization method based on gradients. For an isolation forest, server constructs multiple random trees using random feature selections and split values, and computes path lengths for each training sample. Server outputs trained model parameters and associated decision rules, such as anomaly score computation formulas and threshold values, and stores them in a model repository.

### Step 5:

Server evaluates new communication information using the decision rules and detects abnormal behaviors.

Server receives, as input, newly generated feature vectors for recent time windows from the feature storage area and the trained model parameters and thresholds from the model repository. Server applies the same preprocessing transformations used during training, such as scaling feature values. For an autoencoder, server feeds each preprocessed vector through the neural network and computes reconstruction error; for an isolation forest, server computes an anomaly score based on tree path lengths. Server compares the computed values to stored thresholds and applies logical criteria to classify each feature vector as normal or abnormal. Server outputs detection results that include anomaly scores, classification labels, and associated communication identifiers, and stores these detection results as history information.

### Step 6:

Server generates control information for a communication control apparatus based on detected abnormal behaviors.

Server receives, as input, the detection results from Step 5, including identifiers of abnormal communications such as attacking source addresses and targeted ports. Server applies transformation rules to convert these identifiers into control entries, such as block rules, rate-limiting rules, or alert rules. Server groups similar abnormal behaviors and determines parameters such as block duration, rate limits, or priority level according to predefined policies. Server then formats the control entries into a control information structure compatible with the communication control apparatus, such as a rule list or policy object. Server outputs updated control information and transmits it to the communication control apparatus through a management interface, thereby causing the apparatus to modify its real-time handling of network traffic.

### Step 7:

Server constructs input sentences including prompt sentences for interaction with a generative AI model.

Server receives, as input, current configuration data, history information, and system status metrics. Server selects target tasks for which generative assistance is required, such as log schema design, feature engineering, algorithm selection, threshold adjustment, or defense rule synthesis. Based on the selected task, server generates a prompt sentence in natural language. For example, server may generate the following prompt sentence:

“Design a feature set for anomaly detection in data center network traffic using fields such as source IP, destination IP, ports, protocols, byte counts, and timestamps.”

Server embeds the prompt sentence into an input sentence that may further include summarized context and constraints. Server outputs the input sentence and transmits it to the generative AI model via a network interface.

### Step 8:

Server receives and interprets output information from the generative AI model.

Server receives, as input, output information returned by the generative AI model in response to the input sentence generated in Step 7. Server parses the output information to extract structured elements such as lists of fields, feature definitions, suggested algorithms, hyperparameters, threshold adjustment rules, or recommended defense actions. Server applies parsing operations such as tokenization, pattern matching, and schema mapping from natural-language expressions to internal configuration objects. Server outputs internal configuration data structures, such as updated feature definitions, model parameter sets, or defense policy templates, that will be applied to the subsequent processing.

### Step 9:

Server updates data collection, feature generation, and learning configurations using AI-generated information.

Server takes as input the configuration data structures produced in Step 8. Server compares the AI-generated configurations with current configurations for data collection, feature extraction, learning process, and threshold setting. Server computes differences and resolves conflicts according to priority rules and safety constraints, such as ensuring that critical monitoring fields are not removed. Server then updates configuration files, parameter tables, and internal state variables used by modules in Steps 1 through 5. For example, if the AI-generated configuration recommends a new sampling rate, server modifies sampling parameters for packet capture; if new features are proposed, server adjusts the feature computation formulas. Server outputs updated module configurations that are activated in subsequent processing cycles.

### Step 10:

Server generates defense behaviors with assistance of the generative AI model.

Server receives, as input, detailed lists of abnormal behaviors detected in Step 5 and optional history of previous defense results. Server constructs a prompt sentence such as:

“For the following anomalous traffic events, generate specific firewall rules and rate-limiting policies to block or mitigate attacks while minimizing impact on legitimate traffic.”

Server transmits an input sentence containing the prompt sentence and summarized event data to the generative AI model. Server then receives generated defense recommendations as output information, which may specify types of actions, target addresses, ports, and durations. Server validates these recommendations against fixed safety constraints, such as excluding core infrastructure addresses from automated blocking. Server outputs an approved set of defense behaviors and converts them into concrete control commands for the communication control apparatus.

### Step 11:

Server applies defense behaviors and records their results.

Server receives, as input, the approved defense behaviors from Step 10 in the form of concrete control commands and parameters. Server sends these commands to the communication control apparatus, for example by invoking a configuration application programming interface or issuing CLI commands over a secure channel. Server then monitors subsequent communication information by reading data from the network devices as in Step 1, and correlates changes in traffic patterns with applied defense behaviors. Server computes evaluation metrics such as reduction in attack-related traffic, occurrence of unintended blocking, and time to mitigation. Server outputs evaluation results and stores them, together with identifiers of the applied defense behaviors and timestamps, as part of the history information.

### Step 12:

Server summarizes history information and refines decision rules and execution conditions.

Server receives, as input, accumulated history information, including detection results from Step 5, defense actions from Step 11, and evaluation metrics. Server aggregates this history over specified periods and computes summary statistics such as false positive rate, false negative indicators, mean response time, and correlation between thresholds and incident counts. Server constructs a prompt sentence such as:

“Analyze the recent history of anomaly detections and defense actions, identify false positives and missed attacks, and propose updated anomaly thresholds, feature modifications, and conditions for automatic execution of defense behaviors.”

Server transmits an input sentence containing the prompt sentence and the summary statistics to the generative AI model, receives output information including threshold update information, feature addition or deletion instructions, and updated automatic execution conditions, and translates this information into updated decision rules and policy parameters. Server outputs refined decision rules and execution conditions and replaces older versions in the model repository and policy storage, thereby closing the adaptation loop.

### Step 13:

Terminal presents information to the user and receives user feedback.

Terminal receives, as input, structured data sent by the server, including detection results, AI-generated explanations, defense plans, configuration changes, and performance summaries. Terminal renders this data on graphical user interface components, such as tables of incidents, charts of anomaly scores, and configuration panels. Terminal allows the user to select incidents, view detailed context, and perform actions such as approving or rejecting proposed defense behaviors, adjusting sensitivity levels, or relabeling incidents. Terminal transmits the user's inputs back to the server as control messages. Server interprets these inputs as modifications to labels in the history information, approvals for configuration application, or manual overrides of defense actions. Server outputs updated history records and configuration states that incorporate the user's feedback and influence subsequent interactions with the generative AI model and the internal learning processes.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional security systems typically generate and update detection rules and defense policies by manually analyzing security reports and vulnerability information and by applying static machine learning models to historical attack data. Such systems suffer from several technical limitations. First, these systems are slow to adapt to novel or mutated attack patterns because the generation of new attack rules and patches depends on human experts who must interpret unstructured security-related text and convert it into machine-readable rules. This creates latency and limits coverage against rapidly evolving threats. Second, conventional systems treat user interaction merely as a trigger for policy enforcement and do not model user behavior and emotional reactions as machine-usable signals. As a result, user interfaces for security warnings are often designed in an ad-hoc manner, leading to excessive pop-ups, non-optimal timing of prompts, and ambiguous wording that can cause user fatigue, confusion, and distrust. In practice, such poor interaction design degrades the effective security level because users start to ignore warnings or disable protective functions. Furthermore, typical architectures separate technical defense optimization from user interaction design. Existing intrusion detection and firewall systems optimize detection accuracy and performance without taking into account how the chosen thresholds or alerting strategy will impact user acceptance over time. Conversely, user interface adjustments, if any, are not systematically linked to measured technical performance metrics such as detection rate, false positive rate, or performance overhead. This disconnect prevents the system from globally optimizing the trade-off between protection strength and usability.

Existing applications of generative artificial intelligence models in security are generally limited to offline analysis or advisory text generation. They do not provide a concrete, integrated mechanism to: (i) automatically transform heterogeneous security-related text data into structured attack pattern data; (ii) automatically design and refine defense measure data including machine-readable rules and user interface templates; and (iii) close the loop by feeding back real-time user behavior and emotional state, together with simulation-based technical evaluation indices, into the generative model to drive continuous, autonomous optimization. In particular, there is no established computer-implemented framework that uses prompt sentences to coordinate a generative artificial intelligence model with log aggregation, emotion estimation, rule generation, simulation evaluation, and user interface control modules in a unified, programmable way.

Accordingly, there is a need for a computer-implemented technology that improves the functioning of security processing systems themselves by: (1) automatically converting unstructured security-related information into structured attack pattern data and defense measure data using a generative artificial intelligence model guided by prompt sentences; (2) automatically estimating user emotional states from detailed operation logs and integrating such estimates into the design and adjustment of both technical defense parameters and user interface behavior; and (3) continuously and autonomously updating defense rules and user interface templates based on both technical simulation evaluation indices and predicted emotional impact, thereby enhancing adaptability to new threats while maintaining high user acceptance.

The specific processing by the specific processing unit 290 of the data processing device 12 in Example 2 is realized by the following means.

The present invention provides a server comprising a processor configured to acquire security-related information from external information sources and store the security-related information in a security-related information storage; to analyze the stored security-related information by using natural language processing and machine learning, to extract feature information related to attack methods, and to generate attack pattern data on the basis of the feature information and the security-related information; to generate defense measure data including intrusion detection rules, communication control rules, program correction data, and user interface warning message candidates on the basis of the attack pattern data; to apply the defense measure data to a virtual execution environment, to execute simulated attacks in accordance with the attack pattern data, and to calculate evaluation indices including at least one of a detection rate, a false positive rate, a pop-up display frequency, and a performance impact; to acquire operation history information and response information from terminal devices on the basis of user operation events and responses to security screens, and to estimate an emotional state of a user as emotion scores on the basis of the operation history information and the response information; to generate a prompt sentence including at least part of the security-related information, the feature information, the attack pattern data, the emotional state, and the evaluation indices, and to input the prompt sentence to a generative artificial intelligence model so as to cause the generative artificial intelligence model to execute at least part of generation or refinement of the attack pattern data, generation or refinement of the defense measure data, determination of improvement contents of protection policies and user interface settings including at least one of a threshold, an upper limit of pop-up frequency, a suppression time, a re-authentication interval, and a revision of warning wording, and adjustment of wording, frequency, and display timing of warning messages of a user interface; and to dynamically control display wording, display frequency, display timing, and operation request content of the user interface included in the defense measure data on the basis of the emotional state and the evaluation indices so as to continuously and autonomously update the defense measure data and user interface templates and optimize a balance between user acceptance and a protection level. This enables the computer system to automatically and iteratively transform heterogeneous security-related text data and fine-grained user behavior logs into structured attack patterns, adaptive defense rules, and emotion-aware user interfaces by coordinating a generative artificial intelligence model via prompt sentences, thereby improving the technical performance, responsiveness, and robustness of security processing beyond what is achievable with manual rule design and static machine learning techniques.

The term “security-related information” refers to information concerning risks and countermeasures in computer systems and communication networks, including but not limited to vulnerability information, attack method information, attack incident information, defense measure information, and log information.

The term “security-related information storage” refers to an information storage apparatus or a logical collection thereof that stores security-related information in a structured manner so that the information can be searched, updated, and analyzed.

The term “feature information” refers to attribute values, pattern information, classification information, and other feature quantities extracted from security-related information, which characterize attack methods, vulnerabilities, or defense measures, including at least attack categories, exploited vulnerability types, attack paths, and targeted assets.

The term “attack pattern data” refers to data representing a modeled form of an attack method on the basis of feature information and security-related information, the data including at least prerequisites of the attack, an outline of attack steps, and observable traces in logs or network traffic.

The term “defense measure data” refers to data representing contents of defensive actions corresponding to attack pattern data, the data including at least intrusion detection rules, communication control rules, program correction data, configuration change information, and user interface warning message candidates.

The term “intrusion detection rules” refers to rule information defining decision conditions for detecting a possibility of an intrusion or attack on the basis of patterns, signatures, threshold conditions, or other criteria in network traffic or system logs.

The term “communication control rules” refers to rule information defining control conditions for permitting, blocking, or restricting communication on the basis of at least one of source address, destination address, port number, protocol type, or payload characteristics.

The term “program correction data” refers to data representing correction contents applied to program code having a vulnerability, including at least patch information, code difference information, and configuration change information.

The term “virtual execution environment” refers to an execution environment configured by using at least one of virtual machines, containers, or emulators, the execution environment being capable of emulating a configuration and behavior equivalent or similar to an actual system.

The term “evaluation indices” refers to quantitative indicators calculated for evaluating the effectiveness and impact of defense measure data, including at least one of a detection rate, a false positive rate, a pop-up display frequency, and a performance impact.

The term “operation history information” refers to recorded information indicating operations performed by a user on a terminal device, including at least key inputs, click operations, tap operations, screen transitions, button selections, and associated timestamps, frequencies, and orders.

The term “response information” refers to information indicating responses of a user to user interfaces such as warning dialogs, confirmation screens, and notification screens, including at least button selections, requests for detailed display, ignore operations, close operations, and response times.

The term “emotional state” refers to information representing a psychological state of a user, the information being expressed as intensity values for respective emotion categories including at least anxiety, confusion, anger, indifference, and relief, or as a combination of such intensity values.

The term “emotion score” refers to a numerical value assigned to an emotion category to represent the degree or intensity of the corresponding emotion of a user.

The term “generative artificial intelligence model” refers to a machine learning model that receives natural language text, code, rules, or other structured input and generates new text, code, rules, summaries, classifications, or other outputs on the basis of learned parameters, including at least a large language model.

The term “prompt sentence” refers to input text described in natural language or a similar format and provided to a generative artificial intelligence model to instruct desired processing contents, prerequisites, and input data.

The term “data collection unit” refers to a functional unit implemented by hardware and software that acquires security-related information from external information sources, converts the security-related information into a predetermined format, and stores the converted information in the security-related information storage.

The term “attack pattern generation unit” refers to a functional unit implemented by hardware and software that analyzes security-related information stored in the security-related information storage using natural language processing and machine learning, extracts feature information related to attack methods, and generates attack pattern data on the basis of the feature information and the security-related information.

The term “defense measure development unit” refers to a functional unit implemented by hardware and software that designs and generates defense measure data including intrusion detection rules, communication control rules, program correction data, and user interface warning message candidates on the basis of attack pattern data, and that updates existing defense measure data when necessary.

The term “simulation evaluation unit” refers to a functional unit implemented by hardware and software that applies defense measure data to a virtual execution environment, executes simulated attacks in accordance with attack pattern data, acquires application results of the defense measure data, and calculates evaluation indices including at least a detection rate, a false positive rate, and a performance impact.

The term “emotion estimation unit” refers to a functional unit implemented by hardware and software that receives operation history information and response information from terminal devices, optionally receives user text information, and estimates an emotional state of a user by using a machine learning model or a generative artificial intelligence model.

The term “generative artificial intelligence utilization unit” refers to a functional unit implemented by hardware and software that generates prompt sentences including at least one of security-related information, feature information, attack pattern data, defense measure data, emotional states, and evaluation indices, inputs the prompt sentences and related data to a generative artificial intelligence model, and acquires, as outputs of the generative artificial intelligence model, at least attack pattern data, defense measure data, evaluation results, and improvement proposals.

The term “user interface control unit” refers to a functional unit implemented by hardware and software that selects or changes display wording, display frequency, display timing, and operation request content of a user interface on the basis of an emotional state and evaluation indices, and that controls screen display and operation flow on a terminal device.

The term “terminal device” refers to a client computing apparatus operated by a user, including at least a desktop-type information processing apparatus, a portable information terminal, or a mobile communication terminal, which executes a security agent and presents user interfaces such as warning dialogs and confirmation screens.

The term “user interface warning message candidate” refers to a text template or content candidate for warning messages, confirmation messages, or notification messages in a user interface, the candidate being designed to appropriately convey security risk while considering the emotional state of a user.

In the following embodiments, a “server” denotes one or more information processing apparatuses deployed in a data center or cloud environment and interconnected over a communication network, a “terminal” denotes a client computing apparatus operated by a user, and a “user” denotes an operator of the terminal.

Server executes the core security processing program as one or more processes or services on a general-purpose operating system such as a server-class operating system. Server comprises at least one multi-core central processing unit (CPU), at least one graphics processing unit (GPU) for acceleration of deep learning inference, volatile memory, non-volatile storage, and a network interface. Server executes a relational database management system, a full-text search engine, a message queuing system, an application framework, and a container or virtual machine environment. In one example, server executes a relational database engine implementable as PostgreSQL, a document and search engine implementable as a full-text indexer, a message queue implementable as a distributed log system, and an application framework implementable as an HTTP server framework. Server hosts a generative AI model implemented by a deep learning framework such as PyTorch or TensorFlow, exposed via an HTTP-based inference API.

Terminal executes a client operating system such as a desktop operating system, a mobile operating system, or a notebook operating system, and runs a security agent as a background process or system service. Terminal comprises at least one CPU, memory, local storage, input devices such as keyboard, pointing device, or touch panel, and a display device. Terminal executes native user interface frameworks or web-based user interface technologies to present security dialogs, confirmation screens, and notification panels to user.

User operates applications such as web browsers, mail clients, or business applications on terminal. User responds to security-related prompts, warnings, and confirmation messages rendered by the security agent and continues everyday tasks while the agent monitors interactions.

Server implements a data collection function in software executed by the CPU. Server periodically issues HTTP or HTTPS requests, using a generic HTTP client library, to external sources such as vulnerability repositories, security report sites, technical blogs, forums, and academic repositories. Server retrieves unstructured security-related text documents and metadata, removes markup using an HTML parser, and normalizes character encoding. Server stores structured parts of the security-related information, such as identifiers, severity levels, and affected products, into relational tables in the relational database engine. Server stores unstructured text content into full-text indices of the search engine. This data structure enables efficient retrieval of security-related information by keyword, pattern, or attribute.

Server implements a natural language processing pipeline for security-related information. Server utilizes a morphological analyzer, for example a tokenizer for the relevant language, to segment text into tokens. Server converts tokens into vector representations using word embeddings or sentence encoders implemented with the deep learning framework, such as a transformer-based encoder. Server clusters security documents and incidents using a machine learning library, for example by applying k-means clustering in a high-dimensional vector space. Server thereby groups similar attacks and vulnerabilities. Server computes feature information for each cluster by aggregating token statistics, context descriptions, and structured metadata; feature information comprises attributes such as attack category, exploited vulnerability class, protocol type, typical target asset, and common preconditions. Server stores feature information as records in a feature table in the relational database engine, with columns for category, preconditions, observable log characteristics, and related identifiers. Because the clustering and feature extraction run automatically and incrementally, server can adapt to newly ingested documents faster than a human analyst could.

Server executes an attack pattern generation program that constructs attack pattern data from feature information and underlying documents. Server retrieves representative documents per cluster through similarity queries to the full-text index and assembles concise summaries of exploits and incidents via extractive or abstractive summarization. In one variant, server calls the generative AI model configured as an encoder-decoder transformer network with multiple attention heads, a specified number of layers, and pre-trained on a large corpus of technical text. Server passes a summarization prompt sentence and the selected documents to this model to obtain a compressed explanation of the attack. Server then forms a second prompt sentence describing requirements for attack pattern structuring and sends it to the same or another generative AI model instance.

Server, for example, generates an attack-pattern prompt sentence such as:

“Based on the following vulnerability information summary and known attack case summaries, generate a new attack method pattern.

### [Vulnerability Information Summary]

A web application uses outdated authentication logic that allows session fixation.
The application does not invalidate old session IDs after login.

### [Known Attack Case Summary]

Attackers send crafted URLs containing fixed session IDs.
Victims log in using those URLs, and attackers hijack the authenticated sessions.

The output must include:
Attack prerequisites
An outline of the attack steps
Observable traces on the defender side (log patterns and traffic patterns)

Do not describe concrete exploit code or step-by-step execution instructions.”

Server inputs this prompt sentence, encoded as tokens, to the generative AI model. Internally, the model comprises multiple transformer blocks, each block including multi-head self-attention, feed-forward layers, layer normalization, and residual connections. Server sets generation parameters, such as maximum output length, temperature, and nucleus sampling parameters, and receives a generated text that divides content into sections corresponding to prerequisites, steps, and observable traces.

Server post-processes the output text with deterministic rules: server detects section headings by pattern matching, splits step lists by numeric prefixes, and normalizes phrasing. Server maps the extracted items into a structured attack pattern data object, with fields for prerequisites, ordered steps, and observable traces. Server writes this object as a row in an attack-pattern table in the relational database engine and optionally indexes its textual fields in the full-text search engine.

Server implements a defense measure development program that converts attack pattern data into machine-readable defense measure data. Server generates a defense-design prompt sentence that includes an attack pattern summary and, in some embodiments, aggregated emotional states of users. Server may construct a prompt sentence such as:

“You are a cyber security architect and a user experience expert.

Design defensive measures against the following attack pattern.

### [Attack Pattern Summary]

Category: Session fixation
Prerequisites: session IDs in URLs, no invalidation after login, partial HTTPS.
Observable traces: same session ID used from multiple IP addresses, etc.

### [Average User Emotional State]

Anxiety: 0.8
Confusion: 0.6
Indifference: 0.3

### [Requirements]

1. Network-level defense policy (firewall and intrusion detection/prevention).
2. Application code modification policy.
3. Candidate warning messages that convey risk without unnecessarily increasing anxiety.
4. Automatic defense mechanisms that minimize required user operations.

Output the result as bullet points for each of the above four items.”

Server inputs this prompt sentence to the generative AI model. The model generates text specifying conditions for intrusion detection rules, such as patterns in HTTP headers or session identifiers, and suggests firewall control patterns based on IP address, port, and protocol. Server parses these conditions using pattern-matching and grammar rules and converts them into rule representations suitable for existing intrusion detection engines and firewall systems, for example rule sets that include fields for source and destination address ranges, ports, protocol numbers, content signatures, and thresholds for anomaly scores. Server also maps high-level program correction recommendations, such as “invalidate previous session IDs at login,” into structured program correction data referencing affected modules, configuration parameters, and patch instructions, which can be consumed by separate static analysis and code deployment tools.

Server stores the resulting defense measure data in relational tables that separate intrusion detection rules, communication control rules, program correction data, and user interface templates. Each record includes metadata such as associated attack pattern identifier, version number, creation time, and applicability conditions. This structured representation enables server to apply and rollback defense measures programmatically and atomically.

Terminal implements a user behavior acquisition program as part of the security agent. Terminal registers event hooks through operating system APIs to receive input events such as key presses, mouse clicks, touch gestures, window focus changes, and view transitions. When terminal receives an event, terminal constructs an event record with fields for event type, timestamp, focused window identifier, control identifier, and context attributes. Terminal intercepts events related to security dialogs, including warning displays, confirmation messages, and notification banners, logging the displayed message identifier, enumerated button options, the button actually chosen by user, and the elapsed time from display to response.

Terminal buffers event records in memory or writes them into a lightweight local relational store such as an embedded database. At predetermined intervals or when buffer thresholds are met, terminal serializes unsent events into a textual representation such as JavaScript Object Notation and transmits them via a secure protocol such as HTTPS to server using a generic HTTP client. By batching and compressing logs, terminal reduces communication overhead. Server executes a log ingestion program using an application framework. Server exposes an HTTP endpoint for log reception, authenticates requests using tokens or certificates, and parses request bodies into individual event records. Server normalizes identifiers, converts timestamps to a canonical time zone, and maps event types to a canonical coding scheme. Server writes normalized records into a message queue and into an ingestion table in the relational database. This design allows server to decouple ingestion from downstream aggregation, thereby improving throughput and reliability under load.

Server executes a behavior feature extraction program that consumes events from the queue or ingestion table. Server groups events by user identifier and time interval, such as fixed-length windows, and computes summary statistics: counts of warning dialogs, proportions of immediate closes, rates of “view details” usage, numbers of “back” operations in settings pages, and mean response times. Server also performs text analysis on user-entered free text, using tokenization and lexicons to count occurrences of negative or confusion-related words. Server organizes these quantities into behavior feature vectors with defined positions for each feature. Server writes these vectors into a dedicated table that serves as input for emotion estimation.

Server executes an emotion estimation program that uses the generative AI model to estimate user emotional states. Server constructs a prompt sentence by embedding behavior feature values and text samples into a template, for example:

“You are an AI assistant that performs psychological analysis of user behavior.

Read the following user behavior statistics and text samples, and evaluate this user's current emotional state on a 0-1 scale for each of the five emotions:
anxiety, confusion, anger, indifference, and relief.

### [Behavior Statistics]

Total number of clicks in the past 30 minutes: 120
Immediate close rate of warning dialogs: 80%
Detail button click rate: 10%
Number of “back” operations in the settings screen: 5
Number of occurrences of negative keywords: 3

### [Text Sample]

“Honestly, I have no idea what I should do to stay safe. All these pop-ups are scary.”

The output must contain scores for anxiety, confusion, anger, indifference, and relief”

Server chooses a generative AI model variant that has been fine-tuned for emotion scoring. In one embodiment, server employs a transformer architecture with an additional regression head on top of the pooled representation, trained on annotated behavior-text pairs with ground-truth emotion scores. Training uses a mean squared error loss function between predicted and true scores, optimized by stochastic gradient descent with adaptive learning rate. Data augmentation techniques, such as synonym substitution and noise injection, increase robustness. During inference, server constrains the model to output structured scores or to generate text that can be reliably parsed.

Server parses the model output, which may be formatted as explicit lines such as “Anxiety: 0.86”, and extracts numerical values. Server clips values to a valid range and stores the resulting emotional state record in a table keyed by user and time. By automating this scoring, server can update user emotional profiles at short intervals, enabling responsive adaptation of user interface behavior.

Server combines technical and emotional information to evaluate defenses and refine both rules and user interface settings. Server deploys defense measure data into a virtual execution environment implemented by a virtualization platform such as virtual machines or containers.

Server configures virtual networks, installs intrusion detection engines and application instances, and applies firewall rule sets generated by the defense measure development program. Server scripts simulated attacks based on attack pattern data and executes them using traffic generators or custom tools. Server collects resulting logs and metrics, computes detection rates and false positive rates, and measures processing overhead such as CPU usage and response latency.

Server constructs prompt sentences for emotional impact simulation by including defense measure summaries, technical evaluation indices, and aggregated emotional distributions. An example prompt sentence is:

“Assume that the following defense measures are applied in a corporate network used by typical employees, and simulate a one-day user operation scenario and emotional changes.

### [Defense Overview]

Session fixation countermeasures: automatic session invalidation and blocking of suspicious session reuse.
Pop-up warnings when suspicious session reuse is detected: detailed message with recommended actions.

### [Technical Evaluation Results]

Attack detection rate: 98%
False positive rate: 5%
Frequency of pop-up displays in daily use: 15 times/day

### [Current User Emotional Tendency]

40% of users have high anxiety scores
20% of users have high indifference scores

### Output:

1. A scenario describing a typical user's day divided into 3-5 time segments.
2. Changes in the estimated emotion scores for each segment.
3. Identification of factors that cause dissatisfaction or confusion.”

Server inputs this prompt sentence to the generative AI model, which generates narrative descriptions and estimated emotional trajectories. Server applies natural language processing to identify segments with high predicted anxiety or frustration and to extract references to specific user interface behaviors or rule-induced events. Server writes these emotional impact evaluations into a database and relates them back to rule identifiers and user interface templates.

Server then constructs feedback-oriented prompt sentences that instruct the generative AI model to propose concrete parameter adjustments. Server may use a template such as:

“Based on the following evaluation results after applying the defense measures and the actual changes in user emotions, improve the defenses and the user interface.

Prioritize proposals that reduce anxiety and anger scores while maintaining the defense level.

### [Summary of Technical Evaluation Results]

Detection rate remains high at 98%.
False positive rate is 5%.
Pop-up frequency is 15 times/day.

### [Summary of User Emotional Changes]

Average anxiety increased from 0.4 to 0.7.
Complaints about confusing warnings increased.

### [Requirements]

1. Adjustment of pop-up frequency and content.
2. Strengthening automatic defenses for indifferent users.
3. Parameter changes that do not lower the technical defense level.

Include specific example values for configuration parameters and example revised warning messages for each item.”

Server parses the resulting recommendations, extracting numerical suggestions for maximum daily pop-up counts, minimum suppression intervals, re-authentication intervals, and detection thresholds. Server stores these values in policy parameter tables and updates user interface templates with revised wording, classifying each template by target emotional profile (for example, templates for high-anxiety users versus low-anxiety users).

Terminal periodically requests policy updates from server, providing identifiers for current policy versions and terminal attributes. Server responds with defense rules and user interface templates applicable to the requesting terminal and users, considering emotional state distributions if desired. Terminal validates response integrity and applies network rule changes to local firewall and monitoring components via operating system interfaces. Terminal also updates local user interface configuration so that, upon future security events, terminal selects appropriate warning templates based on recent emotional state data provided by server or inferred locally. For instance, terminal may present short, reassuring messages without technical jargon to a user with a high anxiety score, while a user with low confusion and higher technical familiarity may receive more detailed explanations and optional links to deeper information.

This architecture yields technical improvements beyond mere automation of human tasks. Server transforms heterogeneous, high-volume text and log data into structured representations and optimized rules using a coordinated sequence of machine learning models, generative AI with prompt sentences, and deterministic parsers. Because server uses a virtual execution environment to evaluate defenses and leverages feedback from emotion-aware simulations, server can adjust configurations rapidly when detection performance deteriorates or user acceptance declines, reducing the time window of vulnerability and decreasing false alarms more effectively than static rules. The modular data structures and pipeline reduce computation by allowing incremental updates: only affected attack patterns and defense measures are regenerated when new security information arrives, and only impacted user interface templates are changed when emotional patterns shift.

By integrating emotion estimation directly into rule design and user interface control, server reduces unnecessary user prompts and consolidates alerts, which in turn reduces network traffic (fewer alert messages) and client processing overhead, while helping maintain a high effective protection level because users are less likely to ignore important warnings. The use of deep neural network architectures, explicit loss functions, and structured feature vectors enables server to achieve higher accuracy in both attack pattern abstraction and emotional state estimation compared to heuristic or manual methods. The closed-loop design, where simulation-derived technical metrics and predicted emotional reactions feed back into generative AI-driven refinement, represents a non-conventional, computer-centric method that improves the functioning of the combined security processing and user interface control system, rather than simply replicating manual expert workflows.

In alternative embodiments, server may replace certain components or algorithms while preserving the overall data flow. For example, server may implement the generative AI model as a sequence-to-sequence recurrent neural network instead of a transformer, or may employ different learning objectives such as cross-entropy loss for classification or contrastive loss for embedding learning. Server may employ graph-based clustering instead of k-means, or use a rule-based engine to validate generative AI outputs before deployment. Terminal may be a dedicated security appliance or a virtual desktop rather than a physical workstation. The virtual execution environment may comprise containers orchestrated by a container orchestrator or full virtual machines managed by a hypervisor. The emotion estimation may be performed by a discriminative neural network trained specifically for emotion recognition instead of a general-purpose generative model, while the generative AI model remains responsible for pattern and rule generation.

In each case, server coordinates these modules by generation and interpretation of prompt sentences fed into a generative AI model and by storage and retrieval of structured data in databases, thereby enabling the system to continuously and autonomously refine attack patterns, defense rules, and user interface behaviors in a technically efficient manner.

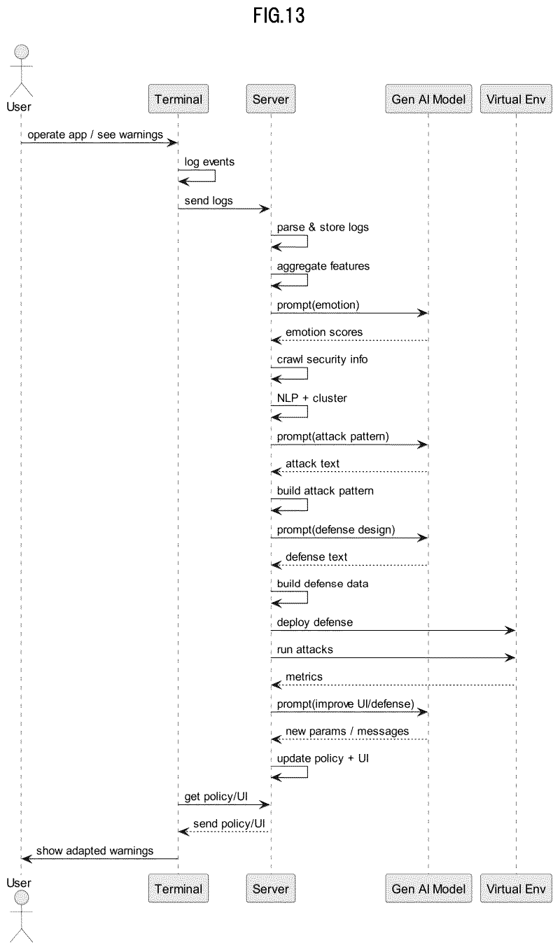

The following describes the processing flow using FIG. 13.

### Step 1:

Server collects external security-related information.

Server sends HTTP or HTTPS requests to external information sources such as vulnerability repositories, security report sites, technical blogs, forums, and academic repositories using an HTTP client library. Server receives HTML pages, JSON feeds, or document files, strips markup, normalizes character encoding, and extracts fields such as identifiers, timestamps, affected components, and textual descriptions.

Input: Raw data retrieved from external security information sources (HTML, JSON, text, documents).

Output: Normalized security-related information records, with structured fields and cleaned text.

Server performs data parsing and normalization by applying HTML parsing, text cleaning, and field extraction rules so that heterogeneous documents are converted into consistent internal record structures.

### Step 2:

Server stores security-related information in internal storage.

Server writes extracted structured fields into relational tables of a database management system and indexes unstructured text in a full-text search engine. Server associates each record with a source identifier, retrieval time, and content hash to prevent duplication.

Input: Normalized security-related information records from Step 1.

Output: Persistent security-related information stored in a security-related information storage (relational tables and full-text indices).

Server executes database insertion and indexing operations that convert in-memory records into durable, queryable data structures.

### Step 3:

Server performs natural language processing and clustering on security-related information.

Server retrieves batches of security-related documents from the storage and tokenizes text using a morphological analyzer. Server converts token sequences into numerical vector representations using word or sentence embedding models implemented in a deep learning framework. Server applies a clustering algorithm such as k-means or another unsupervised method to group similar documents or incidents in the vector space.

Input: Security-related text data and metadata stored in the security-related information storage.

Output: Cluster assignments and intermediate vector representations for each document or incident.

Server performs data transformation from text to vectors and then performs clustering computations, including distance calculations and centroid updates, to group documents with similar attack characteristics.

### Step 4:

Server generates feature information for attack methods.

Server aggregates token statistics, metadata, and cluster membership to derive feature information, such as attack category, vulnerability type, typical protocol, common preconditions, and observable symptoms. Server uses rule-based extraction and statistical thresholds to determine which terms and attributes are significant within each cluster.

Input: Clustered document groups and vector representations from Step 3.

Output: Feature information records describing attributes of attack methods associated with each cluster.

Server computes frequency counts, term weights (for example, TF-IDF scores), and cluster-level summaries to transform raw clusters into compact, structured feature information.

### Step 5:

Server constructs attack-pattern prompt sentences.

Server selects representative documents from each cluster based on similarity to cluster centroids and extracts short summaries of vulnerabilities and known incidents. Server fills a prompt template for attack pattern generation by embedding these summaries and explicit instructions about required output structure. For example, server generates a prompt sentence:

“Based on the following vulnerability information summary and known attack case summaries, generate a new attack method pattern.

### [Vulnerability Information Summary]

A web application uses outdated authentication logic that allows session fixation.
The application does not invalidate old session IDs after login.

### [Known Attack Case Summary]

Attackers send crafted URLs containing fixed session IDs.
Victims log in using those URLs, and attackers hijack the authenticated sessions.

### The Output Must Include:

Attack prerequisites
An outline of the attack steps
Observable traces on the defender side (log patterns and traffic patterns)

Do not describe concrete exploit code or step-by-step execution instructions.”

Input: Feature information and representative security document summaries.

Output: Textual prompt sentences tailored for generating attack pattern data.

Server performs template filling operations, concatenating static instruction text with dynamic content from the database to build coherent, model-ready prompt sentences.

### Step 6:

Server calls the generative AI model to create textual attack patterns.

Server sends the prompt sentences from Step 5 to a generative AI model via an HTTP-based inference API. Server encodes prompt text into tokens, specifies model parameters such as maximum output length and sampling strategy, and receives generated text that describes attack prerequisites, steps, and observable traces.

Input: Attack-pattern prompt sentences generated by server.

Output: Generated attack pattern descriptions in natural language text.

Server performs remote procedure calls to the inference service, manages request and response payloads, and handles tokenization and detokenization processes implemented by the generative AI framework.

### Step 7:

Server structures generated attack pattern data.

Server parses the text output from the generative AI model using pattern-matching and segmentation rules to detect sections like “Attack prerequisites,” “Attack steps,” and “Observable traces.” Server splits items into lists, normalizes phrases, and maps each element to predefined fields in an internal attack-pattern data schema.

Input: Natural language attack pattern descriptions from Step 6.

Output: Structured attack pattern data objects with fields such as prerequisites, steps, and observable traces.

Server performs text segmentation, string normalization, and schema mapping operations to convert unstructured model output into machine-readable records stored in an attack-pattern database.

### Step 8:

Server generates defense-design prompt sentences using attack pattern data and emotional information.

Server retrieves attack pattern summaries and, when available, aggregated emotional state statistics such as average anxiety or confusion levels from an emotional state storage. Server fills a prompt template for defense design that includes the attack pattern, emotional context, and explicit requirements. For example, server generates:

“You are a cyber security architect and a user experience expert.

Design defensive measures against the following attack pattern.

### [Attack Pattern Summary]

Category: Session fixation
Prerequisites: session IDs in URLs, no invalidation after login, partial HTTPS.
Observable traces: same session ID used from multiple IP addresses, etc.

### [Average User Emotional State]

Anxiety: 0.8
Confusion: 0.6
Indifference: 0.3

### [Requirements]

1. Network-level defense policy (firewall and intrusion detection/prevention).
2. Application code modification policy.
3. Candidate warning messages that convey risk without unnecessarily increasing anxiety.
4. Automatic defense mechanisms that minimize required user operations.

Output the result as bullet points for each of the above four items.”

Input: Structured attack pattern data and aggregated emotional state information.

Output: Defense-design prompt sentences for the generative AI model.

Server performs data retrieval and template population operations to embed structured data fields into human-readable instructions for the model.

### Step 9:

Server calls the generative AI model to generate defense measure proposals.

Server sends the defense-design prompt sentences from Step 8 to the generative AI model through the inference API. Server sets parameters appropriate for structured, list-like output and receives bullet-pointed recommendations covering intrusion detection, firewall policy, program corrections, and user interface messages.

Input: Defense-design prompt sentences generated in Step 8.

Output: Textual defense measure proposals, including rule conditions, mitigation strategies, and UI message candidates.

Server handles the network communication, request queuing, and response parsing associated with this generative inference task.

### Step 10:

Server converts textual defense proposals into structured defense measure data.

Server parses the generated defense text to extract conditions for intrusion detection rules (for example, repeated session IDs from different IPs), firewall decisions (allow or block traffic meeting certain criteria), program correction advice (change session management logic), and candidate warning messages. Server maps these elements into structured records: rule objects with fields for source and destination, ports, protocols, patterns, and thresholds; program correction objects referencing modules and configuration parameters; and UI template objects with message text and metadata.

Input: Natural language defense measure proposals from Step 9.

Output: Structured defense measure data, including intrusion detection rules, communication control rules, program correction data, and UI warning message candidates.

Server executes text parsing, rule synthesis, and schema mapping operations to transform narrative descriptions into machine-enforceable configurations stored in defense-related databases.

### Step 11:

Server deploys defense measure data to a virtual execution environment and runs simulations.

Server configures a virtual environment, such as virtual machines or containers, by applying generated intrusion detection rules and firewall settings to simulated network elements and installing program corrections in virtual application instances. Server then executes simulated attacks that follow attack pattern data by generating crafted network traffic and requests. Server collects logs and performance metrics from the virtual environment and computes evaluation indices, including detection rate, false positive rate, and performance impact.

Input: Structured defense measure data and attack pattern data.

Output: Quantitative evaluation indices describing technical effectiveness and cost of the defenses.

Server performs configuration deployment, test traffic generation, log aggregation, and statistical calculations to evaluate how the proposed defenses behave under controlled attack scenarios.

### Step 12:

Terminal monitors user operations and security screen responses.

Terminal registers event hooks using operating system APIs to capture user interactions such as key presses, mouse clicks, touch gestures, screen transitions, and button activations. When terminal displays a security warning or confirmation dialog, terminal records which message appeared, which option user selected (for example, “Allow,” “Block,” “View details,” “Close”), and how long user took to respond. Terminal constructs structured log records with event type, timestamp, UI element identifiers, and response details.

Input: Real-time user operations and responses to security-related user interfaces.

Output: Event log records representing operation history information and response information.

Terminal performs event interception, record construction, and local buffering operations to capture behavior data without significantly impacting user experience.

### Step 13:

Terminal batches and transmits event logs to server.

Terminal periodically scans its local buffer or embedded database to select unsent event records, serializes them into a text-based format, and sends them to server via HTTPS using an HTTP client. Terminal includes authentication credentials with each request and waits for an acknowledgment. Upon successful transmission, terminal marks or deletes the sent records to avoid duplication.

Input: Locally stored event log records accumulated in Step 12.

Output: Log upload requests transmitted to server containing batched event data.

Terminal performs batch selection, serialization, encryption at the transport layer, and acknowledgement handling to deliver behavior logs reliably and efficiently.

### Step 14:

Server ingests, normalizes, and stores user event logs.

Server accepts HTTPS requests from terminals at a log ingestion endpoint, validates credentials, and parses request bodies into individual event records. Server converts timestamps to a canonical time base, maps event types to standardized codes, and normalizes terminal and user identifiers. Server writes normalized records into a message queue for streaming processing and into staging tables in the relational database for archival.

Input: Batched event log payloads received from terminals in Step 13.

Output: Normalized event records stored in internal queues and tables as operation history information and response information.

Server performs parsing, normalization, and insertion computations that transform arbitrary client logs into consistent internal data suitable for aggregation.

### Step 15:

Server aggregates behavior features from event logs.

Server processes normalized event records in time windows per user, counting events such as total clicks, number of security dialogs, immediate closes, detail views, and “back” operations. Server calculates ratios, such as quick-close rate and detail-view rate, and average response times. Server optionally merges counts of negative terms from textual inputs. Server composes these metrics into fixed-length behavior feature vectors per user and window, and stores them in a behavior feature table.

Input: Normalized operation history information and response information from Step 14.

Output: Behavior feature vectors that summarize user behavior statistics over defined periods.

Server executes grouping, counting, averaging, and ratio computations to compress raw event sequences into numerical feature representations.

### Step 16:

Server constructs emotion-estimation prompt sentences including behavior features and text samples.

Server retrieves recent behavior feature vectors and, where available, associated user text snippets such as feedback comments. Server fills a text template with these values to form a prompt sentence, for example:

“You are an AI assistant that performs psychological analysis of user behavior.

Read the following user behavior statistics and text samples, and evaluate this user's current emotional state on a 0-1 scale for each of the five emotions:
anxiety, confusion, anger, indifference, and relief.

### [Behavior Statistics]

Total number of clicks in the past 30 minutes: 120
Immediate close rate of warning dialogs: 80%
Detail button click rate: 10%
Number of “back” operations in the settings screen: 5
Number of occurrences of negative keywords: 3

### [Text Sample]

“Honestly, I have no idea what I should do to stay safe. All these pop-ups are scary.”

The output must contain scores for anxiety, confusion, anger, indifference, and relief”

Input: Behavior feature vectors and user text samples generated or stored in prior steps.

Output: Emotion-estimation prompt sentences for the generative AI model.

Server performs template substitution and string formatting operations, embedding numeric and textual data into an interpretable instruction text.

### Step 17:

Server calls the generative AI model to estimate emotional states.

Server sends the emotion-estimation prompt sentences from Step 16 to the generative AI model via the inference API, specifying generation constraints that favor concise numerical outputs. Server receives textual responses containing emotion category labels and associated scores, then parses the text to extract numeric values for emotion categories such as anxiety, confusion, anger, indifference, and relief.

Input: Emotion-estimation prompt sentences built in Step 16.

Output: Emotional state records with numerical emotion scores per user.

Server performs generative inference calls, output parsing, numeric conversion, and validation to transform model-generated text into structured emotional state data stored in an emotional state database.

### Step 18:

Server evaluates emotional impact and refines defense measures and user interfaces.

Server combines technical evaluation indices from simulations (detection rate, false positive rate, pop-up frequency) with emotional state distributions from Step 17 to generate new prompt sentences that request improvement suggestions. Server constructs text such as:

“Based on the following evaluation results after applying the defense measures and the actual changes in user emotions, improve the defenses and the user interface.

Prioritize proposals that reduce anxiety and anger scores while maintaining the defense level.

### [Summary of Technical Evaluation Results]

Detection rate remains high at 98%.
False positive rate is 5%.
Pop-up frequency is 15 times/day.

### [Summary of User Emotional Changes]

Average anxiety increased from 0.4 to 0.7.
Complaints about confusing warnings increased.

### [Requirements]

1. Adjustment of pop-up frequency and content.
2. Strengthening automatic defenses for indifferent users.
3. Parameter changes that do not lower the technical defense level.

Include specific example values for configuration parameters and example revised warning messages for each item.”

Server sends these prompt sentences to the generative AI model, obtains improvement proposals containing specific parameter values and revised wording, parses the results, and updates defense policy parameters and UI templates in the database.

Input: Technical evaluation indices, emotional state distributions, and feedback-oriented prompt templates.

Output: Updated defense measure data and user interface templates with refined thresholds, frequencies, and messages.

Server performs data fusion, generative inference, text parsing, and database update operations that close the optimization loop by incorporating both technical and emotional feedback.

### Step 19:

Server distributes updated policies and UI templates to terminals.

Server listens for configuration update requests from terminals, which indicate current policy versions and terminal identifiers. Server determines the applicable set of intrusion detection rules, communication control rules, and UI templates for each requesting terminal, taking into account user group emotional characteristics if desired. Server sends a configuration response containing rules, parameters, and UI template definitions.

Input: Policy and template data stored in server databases and update requests from terminals.

Output: Configuration responses containing updated defense rules and UI templates for terminals.

Server executes selection, packaging, and transmission operations to deliver coherent, versioned configuration bundles to client devices.

### Step 20:

Terminal applies received policies and adapts user interfaces for user.

Terminal receives configuration responses from server, verifies integrity and authenticity, and updates local firewall modules, intrusion detection agents, and security agent configuration according to the new rules and parameters. Terminal also replaces or augments local user interface templates used for security dialogs, including warning text, layout options, and behavior rules. During subsequent security events, terminal chooses specific UI templates based on per-user emotional state information communicated by server or derived locally, so that messages and interaction flows match the user's current tolerance and understanding.

Input: Updated defense policies and UI templates received from server in Step 19.

Output: Modified local defense configuration and adapted user-facing security dialogs displayed to user.

Terminal performs configuration parsing, local rule application, and UI selection logic execution, resulting in real-time system behavior that reflects refined security policies and emotion-aware interaction design.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional network security systems and security operation platforms focus primarily on objective network signals such as packets, flows, and signatures, and on static rule sets and models for intrusion detection and defense control. These systems treat the human operator as an external, fixed-capability component and do not adapt their behavior to the operator's cognitive load, stress level, or other emotional factors. As a result, when alert volumes surge or attack scenarios become complex, operators may experience high stress or confusion. Under such conditions, operators are more likely to overlook critical alerts, misprioritize incidents, or misconfigure defense devices. Existing user interfaces and automation mechanisms, however, continue to present uniform alert lists, fixed levels of detail, and rigid automatic or semi-automatic responses, regardless of the operator's actual state. This mismatch between system behavior and operator state leads to increased error rates and reduces the effective security level, especially during peak incident periods when robust operation is most needed.

In addition, while machine learning and anomaly detection are used to model normal and abnormal traffic patterns, the outputs of these models are typically presented as static alerts or scores. Conventional systems do not systematically integrate these outputs with generative artificial intelligence models capable of producing adaptive natural language explanations and decision support tailored to the operator's condition. Even when generative AI models are introduced, they are often invoked with fixed prompt sentences. These fixed prompts do not vary in structure, emphasis, or level of technical detail according to the operator's emotion state or the dynamic threat context. Consequently, the explanatory content and recommended actions produced by the generative AI model can be either excessively complex or overly simplified, failing to optimally support the operator's real-time decision-making process. Moreover, current feedback mechanisms in security systems primarily evaluate technical performance metrics such as detection rates, false positive rates, and defense success rates. They generally do not record or analyze the correlation between operator emotion states and defense outcomes. Without such correlation, it is difficult to identify patterns of misoperation or suboptimal decisions that are specifically associated with high-stress or fatigue conditions. This lack of fine-grained feedback prevents iterative improvement of both the anomaly detection logic and the human-machine interface in a way that truly reduces operator-induced risk.

From a computer-technology standpoint, there is a need for an improved architecture and processing method in which a processor not only monitors network traffic and executes anomaly detection, but also acquires multimodal user-state data, estimates the operator's emotion state using a trained model, and dynamically configures the behavior of generative AI models and user interfaces. The processor must be able to generate prompt sentences for a generative AI model based on both current anomaly information and the estimated emotion state, and to use the resulting response information to drive defense execution and interface control. By tightly integrating these components within a unified control flow implemented on general-purpose computing hardware, the system can reduce cognitive load-related errors, improve responsiveness to threats, and enhance overall reliability of security operations.

Accordingly, a technical problem to be solved by the present invention is to improve computer-implemented security operation technology by providing mechanisms that: (i) jointly process network traffic data and multimodal user-state data; (ii) estimate an operator's emotion state in real time using a trained emotion classification model; (iii) dynamically construct and supply prompt sentences to a generative AI model in accordance with both anomaly context and emotion state; and (iv) control defense execution and user interface presentation based on the generative AI model's response, while recording feedback that links defense effectiveness to emotion states.

The specific processing by the specific processing unit 290 of the data processing device 12 in Application Example 2 is realized by the following means.

The present invention provides a server comprising a processor and a memory storing instructions that, when executed by the processor, cause the processor to acquire network traffic log data via monitoring software operating on an information processing apparatus, perform statistical or machine-learning-based analysis on the log data to calculate communication feature values, compare the communication feature values with a trained normal traffic model to detect abnormal traffic and generate abnormal event information, acquire user-state input data including at least one of an acoustic signal, a visual signal, an operation event signal, and self-report information from an operator via an input/output apparatus, extract multimodal features from the user-state input data, estimate an emotion state label including at least a normal state and a high-stress state by using a trained emotion classification model, dynamically construct a prompt sentence for a generative AI model based on the emotion state label and the abnormal event information, supply the prompt sentence to the generative AI model and obtain response information generated by the generative AI model, control a user interface to switch an alert presentation method and a level of detail of explanatory content in accordance with the emotion state label and the response information, execute defense processing by converting recommended defense operations included in the response information and a defense action instruction from the operator into control commands for an access control apparatus or an information processing apparatus, and record feedback data including the emotion state label, the abnormal event information, contents of the defense processing, and a defense effectiveness indicator in a storage apparatus. This enables an integrated computer-implemented security operation in which the same processor pipeline continuously monitors network traffic, infers operator emotion state, adapts prompt sentences for a generative AI model, tailors user interface behavior and automation level to the inferred state, and closes the loop by recording defense outcomes linked to emotion states, thereby reducing operator error under high cognitive load and improving the technical performance and robustness of network defense processing.

The term “attack pattern generation unit” refers to a functional unit implemented by a processor that acquires security-related information, performs natural language processing and machine-learning-based analysis of existing attack methods, and generates new or modified attack patterns.

The term “defense measure development unit” refers to a functional unit implemented by a processor that receives generated attack patterns, analyzes characteristics and weaknesses of the patterns, and develops defense measures including updating detection rules, optimizing access control configurations, and creating corrective data for vulnerabilities.

The term “simulation evaluation unit” refers to a functional unit implemented by a processor that builds a simulated environment, executes virtual attacks using developed defense measures, and evaluates the effectiveness of the defense measures based on results of the virtual attacks.

The term “network traffic monitoring unit” refers to a functional unit implemented by a processor that, by using monitoring software on an information processing apparatus, acquires communication data flowing through a communication path and generates log data including identifiers, control information, data volumes, and time information.

The term “log data analysis unit” refers to a functional unit implemented by a processor that performs statistical processing or machine-learning-based processing on log data to calculate communication feature values representing characteristics of network traffic.

The term “abnormal traffic detection unit” refers to a functional unit implemented by a processor that compares communication feature values with a trained normal traffic model, determines whether traffic is abnormal based on the comparison, and generates abnormal event information.

The term “user state acquisition unit” refers to a functional unit implemented by a processor that, via an input/output apparatus, acquires at least one of an acoustic signal, a visual signal, an operation event signal, and self-report information from an operator and structures the acquired data as user-state input data.

The term “emotion state estimation unit” refers to a functional unit implemented by a processor that extracts features from acoustic, visual, behavioral, and self-report data and estimates an emotion state label using a trained emotion classification model.

The term “emotion state label” refers to a symbol or categorical value indicating an operator's estimated emotional or cognitive condition, including at least one of a normal state, a high-stress state, an anxious state, a fatigued state, and a confused state.

The term “prompt sentence generation unit” refers to a functional unit implemented by a processor that selects a prompt template and dynamically constructs a prompt sentence for a generative AI model based on an emotion state label and abnormal event information.

The term “generative AI model cooperation unit” refers to a functional unit implemented by a processor that supplies a prompt sentence to a generative AI model, obtains a natural language response from the generative AI model, and structures the response as response information usable by other units.

The term “user interface control unit” refers to a functional unit implemented by a processor that controls presentation of alerts and explanatory content on a display apparatus, including switching an alert presentation method and a level of detail in accordance with an emotion state label and response information.

The term “defense execution control unit” refers to a functional unit implemented by a processor that interprets a defense action instruction from an operator and recommended defense operations from response information, converts them into control commands for an access control apparatus or an information processing apparatus, and executes defense processing.

The term “feedback recording unit” refers to a functional unit implemented by a processor that evaluates effects of defense processing and records feedback data including emotion state labels, abnormal event information, defense contents, and defense effectiveness indicators in a storage apparatus.

The term “monitoring software” refers to a software component executed by an information processing apparatus that captures communication data on a communication path and outputs packet or flow information as log data.

The term “log data” refers to time-series data recording events related to network communication or defense processing, including at least source identifiers, destination identifiers, communication control information, data volumes, timestamps, and detection or configuration information.

The term “communication feature values” refers to numerical or categorical values derived from log data that represent characteristics of communication flows, including at least flow duration, data volume per unit time, packet count per unit time, and classification information of internal or external communication.

The term “normal traffic model” refers to a model trained from historical communication feature values that represents characteristic patterns of normal network traffic and is used as a reference for anomaly detection.

The term “abnormal event information” refers to structured data describing communication flows determined to be abnormal, including at least identifiers of the flows, source and destination identifiers, ports, anomaly scores, timestamps, and optional category labels.

The term “user-state input data” refers to structured data that aggregates one or more of an acoustic signal, a visual signal, an operation event signal, and self-report information acquired from an operator together with associated timestamps and identifiers.

The term “acoustic signal” refers to audio data representing sound, including an operator's speech or vocal characteristics, captured by an acoustic sensor and used as input for emotion state estimation.

The term “visual signal” refers to image or video data representing at least an operator's face, expressions, or body movements, captured by an image sensor and used as input for emotion state estimation.

The term “operation event signal” refers to data representing events generated by an input operation device, including at least key operations, pointing operations, clicks, and associated timestamps, used as behavioral information for emotion state estimation.

The term “self-report information” refers to data representing an operator's subjective report of emotional or cognitive state, including at least stress level, fatigue level, or selected emotion categories input via a user interface.

The term “trained emotion classification model” refers to a machine learning model trained on labeled multimodal feature data to output probabilities or labels for emotion states based on extracted features.

The term “prompt template” refers to a predefined natural language text pattern including placeholders that can be filled with variable data such as emotion state labels and abnormal event information to form a complete prompt sentence for a generative AI model.

The term “prompt sentence” refers to a natural language instruction text constructed for input to a generative AI model, specifying desired content, structure, and focus of a generated response.

The term “generative AI model” refers to a machine learning model configured to generate natural language text or other content in response to an input prompt sentence, based on patterns learned from training data.

The term “response information” refers to structured data obtained by processing a natural language response generated by a generative AI model, including at least a summary section, an immediate action section, and a supplementary information section.

The term “alert presentation method” refers to a mode or style in which alerts and associated information are displayed on a user interface, including ordering, emphasis, aggregation, and visibility of detailed data.

The term “defense action instruction” refers to a signal or message generated by an operator's input that indicates selection, approval, or modification of one or more defense operations recommended by the system.

The term “access control apparatus” refers to a hardware or software component configured to enforce communication control policies, including at least firewalls, routers, intrusion prevention devices, or access control mechanisms in information processing systems.

The term “information processing apparatus” refers to a general-purpose or specialized computing device including at least a processor, a memory, and communication interfaces, capable of executing programs for monitoring, analysis, control, and user interaction.

The term “defense processing” refers to one or more operations that modify configurations of an access control apparatus or an information processing apparatus to block, limit, or otherwise mitigate abnormal or malicious network traffic or related threats.

The term “defense effectiveness indicator” refers to a quantitative or qualitative measure used to evaluate the impact of defense processing, including at least changes in anomaly scores, changes in alert counts, or occurrence of side effects such as legitimate traffic disruption.

The term “feedback data” refers to stored information that associates defense processing outcomes with corresponding emotion state labels, abnormal event information, and defense effectiveness indicators and is used for subsequent analysis or model refinement.

In one embodiment, a server, a terminal, and a user cooperatively implement the claimed system. The server is realized as a general-purpose information processing apparatus located in a data center, and the terminal is realized as an information processing apparatus operated by the user at an operation site or a remote location.

The server includes at least one multi-core processor, a main memory, a non-volatile storage device such as a solid state drive, and a communication interface connected to a packet-based communication network. The server executes an operating system such as a server-oriented operating system based on a UNIX-like kernel. On this operating system, the server executes monitoring software, a log collection framework, an analysis program implemented in a general-purpose programming language runtime such as a Python runtime, a machine-learning framework such as a tensor computation library, and a communication library for accessing an external or internal generative AI model.

The terminal includes a processor, a memory, a display apparatus, an input operation device such as a keyboard, a pointing device, a microphone serving as an acoustic sensor, and a camera serving as an image sensor. The terminal executes a web browser or a dedicated client application that implements a user interface and communication with the server via a transport protocol such as HTTPS or a bidirectional communication protocol such as WebSocket. The user operates the terminal, observes alerts and explanations on the display apparatus, and inputs defense action instructions through the input operation device.

The server executes monitoring software, such as an intrusion detection engine or a packet capture engine, on its network interface. The server configures a mirror port or a network tap to supply copies of packets flowing through a protected network. The monitoring software aggregates packet headers and, optionally, payload metadata into flow records. Each flow record includes a source address, a destination address, a source port, a destination port, a protocol identifier, a start time, an end time, a packet count, and a byte count. The server provides these flow records as log data to a log collection framework such as a log shipping agent that forwards the log data to a log repository, such as a search engine or a time-series database.

The server executes a log data analysis program implemented in a general-purpose language such as Python. The server uses a numerical computation library to load batches of flow records into memory as structured arrays or tables, for example as matrix-like data structures. The server computes communication feature values by applying data transformation operations to each flow record, such as computing flow duration by subtracting start time from end time, computing bytes per second, computing packets per second, and computing flags indicating whether the source or destination address is part of an internal address range. The server normalizes these feature values, for example by applying a z-score normalization using pre-computed means and standard deviations, and stores them as traffic feature vectors. The server loads a trained normal traffic model into memory. In one embodiment, the server realizes this model as an autoencoder neural network implemented in a tensor computation framework. The server defines the autoencoder as a feed-forward network including an input layer corresponding to the traffic feature dimensions, multiple hidden layers with nonlinear activation functions, and a bottleneck layer representing a compressed latent representation of normal traffic patterns. The server pre-trains this autoencoder on historical traffic feature vectors representing normal traffic. During training, the server minimizes a reconstruction error function, such as a mean squared error between input vectors and reconstructed output vectors, by updating network weights with a gradient-based learning rule such as stochastic gradient descent or an adaptive learning rate optimizer. The server preserves the trained weights on the storage device and loads them at runtime.

The server reconstructs each current traffic feature vector using the autoencoder and computes a reconstruction error as an anomaly score. The server compares the anomaly score to a threshold that the server determines beforehand, for example by analyzing a distribution of reconstruction errors in the training set. When the reconstruction error exceeds the threshold, the server classifies the corresponding flow as abnormal and generates abnormal event information, including the flow identifiers, the anomaly score, and additional metadata from the log data. The server stores abnormal event information in a structured data store accessible by other modules.

The terminal acquires user-state input data. The terminal uses a media capture interface, such as a browser media capture API, to acquire an acoustic signal from the microphone and a visual signal from the camera. The terminal captures audio at a predetermined sampling rate and encodes the audio using a compression codec such as an audio compression codec. The terminal captures video frames at a predetermined frame rate and resolution and encodes the video using a video compression codec. The terminal simultaneously monitors operation events generated by the keyboard and pointing device. The terminal records key codes, pointer coordinates, click types, and timestamps and aggregates these into an operation event signal. The terminal also provides user interface elements such as sliders and selection fields through which the user inputs self-report information indicating stress level or fatigue level. The terminal structures these multimodal inputs as user-state input data. The terminal packages the encoded acoustic signal, the encoded visual signal, the operation event signal, and the self-report information into a composite message that includes session identifiers and timestamps. The terminal transmits the user-state input data to the server over a secure communication channel.

The server receives the user-state input data and executes an emotion state estimation process. The server uses an audio analysis library to decode the acoustic signal and segment it into overlapping frames. The server computes acoustic features for each frame, including Mel-frequency cepstral coefficients, frame energy, and fundamental frequency values. The server uses an image processing library to decode the visual signal and extract frames. For each frame, the server applies a face detection function to locate a face region and a facial landmark detection function to obtain coordinates of facial parts such as eyes, eyebrows, nose, and mouth. The server computes expression features from these coordinates, such as distances between eyebrows and eyes, eye aspect ratios indicating eye openness, and mouth corner displacement vectors. The server also analyzes the operation event signal by grouping events into time windows and computing statistical measures such as mean key interval, standard deviation of key interval, count of error keys, and mean cursor movement speed per window. The server normalizes and concatenates the acoustic features, expression features, and operation behavior features, and aligns them with the self-report information. The server represents this combined feature data as user-feature vectors over time. The server loads a trained emotion classification model into memory. In one embodiment, the server implements this model as a multimodal neural network combining fully connected layers and, optionally, recurrent or attention layers to model temporal dependencies. The server trains this model beforehand using labeled training data that associate user-feature vectors with known emotion labels such as normal state, high-stress state, anxious state, fatigued state, and confused state. During training, the server defines a loss function such as a cross-entropy loss over the output probabilities and the true labels and updates the network weights by backpropagation using an optimizer such as an adaptive gradient optimizer. The server may apply data augmentation techniques, such as adding small noise to acoustic features or perturbing temporal alignment, to improve robustness.

The server inputs the current user-feature vectors into the trained emotion classification model and obtains, for each vector, a probability distribution over emotion labels. The server selects the label with the highest probability as a preliminary emotion state and optionally refines this label by referencing the self-report information. For example, when the self-report indicates a high stress level, the server increases the likelihood of the high-stress label by applying a rule-based adjustment. The server aggregates emotion labels over a short time period and outputs a final emotion state label representing the current emotional condition of the user.

The server executes a prompt sentence generation process based on the emotion state label and the abnormal event information. The server stores prompt templates as text strings with placeholders. The server includes at least one template for a high-stress state and at least one template for a normal state. The server selects a template according to the current emotion state label. The server fills placeholders with values derived from abnormal event information, such as the count of abnormal events, descriptions of top-ranked abnormal events, time ranges, and service identifiers. The server constructs a prompt sentence as a natural language instruction for a generative AI model.

In one example, when the emotion state label indicates a high-stress state, the server constructs a prompt sentence such as:

“The current administrator is in a high-stress state. Analyze the following abnormal network events:

### [Here, the System Inserts a List of Abnormal Events]

1) Select only the single most critical abnormal event and briefly explain why it is the most critical risk right now.
2) Provide at most three very clear, step-by-step operational actions that the administrator should execute immediately in the security console.
3) List all remaining abnormal events as short ‘to-be-checked-later’ items, each on one line, without detailed explanations.”

In another example, when the emotion state label indicates a normal state and the administrator requests detailed technical information, the server constructs a prompt sentence such as:

“The current administrator is in a normal emotional state and wants detailed technical information. Analyze the following network traffic logs and anomaly detection results:

### [Here, the System Inserts a List of Flows and Anomaly Scores]

1) For each abnormal event, explain the detection rationale, including which traffic features were important, which thresholds or model outputs caused the event to be classified as abnormal, and what the exact anomaly score is.
2) Compare these events with similar historical incidents included in the incident history data, and summarize how those incidents were handled and with what outcome.
3) Propose three concrete and technically sound defense policy adjustments to reduce the likelihood or impact of similar anomalies in the future.”

The server acts as a generative AI model cooperation unit. The server uses a communication library to send the prompt sentence to a generative AI model. This generative AI model may be a large language model implemented as a multi-layer transformer network trained on a large corpus of text data. The server connects to the generative AI model via an application programming interface, specifying the prompt sentence, a maximum number of output tokens, and a generation temperature parameter that controls sampling variability. The server receives the natural language response and parses it to identify sections such as a summary section, an immediate action section, and a supplementary information section. The server structures the parsed response as response information stored in a data structure.

The terminal receives the response information and the emotion state label from the server. The terminal acts as a user interface control unit by adapting the layout and content of the user interface according to the emotion state label. When the emotion state label indicates a high-stress state, the terminal displays only the most critical abnormal event and the immediate action steps in a prominent manner, and hides detailed tables and graphs behind collapsible controls. When the emotion state label indicates a normal state, the terminal displays detailed anomaly lists, explanations, and historical comparisons. This adaptive interface reduces cognitive load on the user in stressful situations and allows deep analysis in calm situations. The user reviews the presented information and selects a defense action instruction by clicking a button or selecting a menu item. Such instructions include actions like “Execute all recommended blocks,” “Execute only the top recommended block,” or “Defer action.” The terminal transmits the defense action instruction to the server.

The server interprets the defense action instruction and functions as a defense execution control unit. The server maps recommended operations from the response information to concrete control commands for physical or logical network devices, such as firewall devices, access control devices, or security modules in routers. For example, the server may generate a command to add a blocking rule for a specific source IP address and port combination on a firewall management interface. The server sends these control commands over a secure channel, such as an authenticated API call or an encrypted remote command session. The server receives responses indicating success or failure, logs the results, and may retry or adjust commands in case of errors.

After executing defense processing, the server monitors subsequent network traffic and recomputes anomaly scores to evaluate defense effectiveness. The server compares anomaly scores and alert counts before and after the defense execution. The server calculates defense effectiveness indicators, such as the degree of reduction in anomaly scores associated with the blocked flows and the net change in total alert volume. The server records the emotion state label at the time of the defense processing, the abnormal event information, the defense contents, and the defense effectiveness indicators as feedback data in a storage device.

From a computer technology perspective, this architecture and processing pipeline improve the functioning of the computer system in several ways. By offloading computation-intensive feature extraction and model inference to the server's processor and memory, the system reduces manual inspection and enables real-time analysis of both network signals and user-state signals. The specific autoencoder-based anomaly detection model allows the server to compute anomaly scores using a compressed latent representation, which reduces the dimensionality of feature vectors and thus reduces memory bandwidth and computing resources during inference while maintaining detection precision. The integration of multimodal emotion estimation modifies the processor's control flow: the processor selects different prompt templates and user-interface behaviors depending on estimated emotion state, rather than using fixed, non-adaptive logic. This conditional logic is not a mere automation of human judgment; it is a reconfiguration of computation paths that directly changes resource usage, display patterns, and actuation timing.

The prompt sentence generation mechanism is also specifically designed to reduce communication overhead between the system and the generative AI model. By selecting targeted subsets of abnormal events and formatting them into compact summaries before transmission, the server reduces the size of the prompt, which speeds up network communication and model processing. Conversely, when bandwidth and cognitive load permit, the server can transmit more detailed data for deeper analysis. This adaptive prompting improves throughput and latency of the overall system compared to a fixed, always-detailed explanation pattern.

The disclosed system also improves data management. The server structures abnormal event information, user-state input data, emotion state labels, prompt sentences, response information, and feedback data using defined data structures. The server stores these structures in indexed databases, which enables efficient querying of relationships between emotion states and defense outcomes. By analyzing feedback data, the server can retrain or fine-tune the anomaly detection model and emotion classification model in a controlled manner. For example, the server can adjust training data weighting so that misdetections associated with high-stress states are given higher importance. This feedback-driven optimization is performed inside the computing system without requiring the user to manually analyze relationships, and results in improved detection accuracy and more effective prompt sentence patterns over time.

The emotion classification model and the autoencoder anomaly detection model both utilize neural network architectures that are trained with explicit optimization criteria. The server stores training datasets that consist of pairs of feature vectors and target labels. During training, the server iteratively computes forward passes through the network layers, computes losses such as reconstruction error or cross-entropy, computes gradients of the loss with respect to weight parameters using backpropagation, and updates the weights based on learning rate parameters. The server may include regularization terms in the loss function, such as L2 weight penalties, to improve generalization. These specific training procedures differ from human reasoning and are implemented as precise numerical algorithms executed by the processor.

The described techniques lead to measurable technical effects. Anomaly detection precision is improved by combining reconstructed error-based scores with adaptive thresholds and by providing detailed, model-derived detection rationales via the generative AI model. Operator error rates, such as misapplied defense rules, are reduced because the user interface is simplified under high-stress conditions and because the generative AI model is instructed via prompt sentences to emphasize immediate, low-risk, step-by-step instructions. Overall system performance is improved because adaptive prompting reduces processing time for generative AI responses and because dynamic selection of visible content reduces unnecessary rendering and data transfer between the server and the terminal.

Alternative embodiments are also possible. The server may use different anomaly detection models, such as an isolation forest, a one-class support vector machine, or a clustering-based outlier detector, in place of or in addition to the autoencoder. The server may employ different neural network architectures for emotion classification, such as convolutional networks for image features, recurrent networks or transformers for sequential features, and fusion layers that combine modalities by concatenation or attention mechanisms. The generative AI model may be deployed on-premises or accessed as a remote service. The terminal may be a mobile device or a head-mounted display, and the user-state acquisition may include additional sensors such as accelerometers or physiological sensors. The server may further adjust communication schedules or compression parameters for user-state data and log data based on loaded network conditions and emotion states, thereby providing additional optimization of communication load.

In all these embodiments, the server, the terminal, and the user cooperate through concrete technical means, data structures, and algorithms to realize a system in which a generative AI model and prompt sentences are used not merely for presenting text, but for dynamically controlling defense mechanisms and human-machine interfaces in response to both network anomalies and operator emotion states. This configuration enables the claimed system to achieve technical improvements in detection accuracy, processing speed, error reduction, and resource utilization compared to conventional security operation systems that lack such integrated, adaptive control.

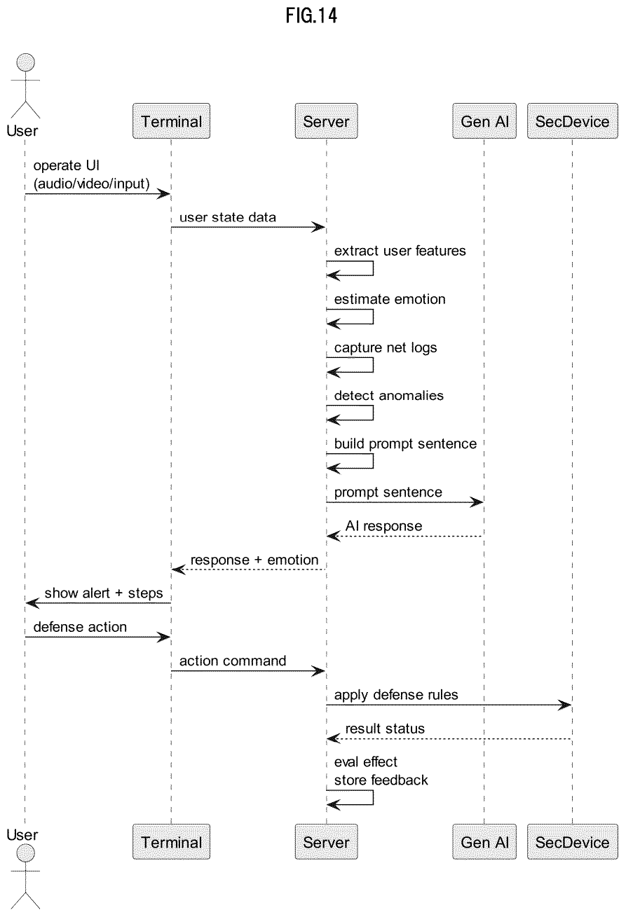

The following describes the processing flow using FIG. 14.

### Step 1:

Terminal acquires user-state input data.

Terminal uses a media capture interface to obtain an acoustic signal from the microphone, a visual signal from the camera, and operation events from the keyboard and pointing device. Terminal displays a user interface including sliders and selection fields to receive self-report information such as stress level and fatigue level from User. The input of Step 1 is raw sensor data (microphone audio, camera video), operation events (key codes, pointer coordinates, click types, timestamps), and self-reported values entered by User. Terminal encodes the audio into compressed audio frames, encodes the video into compressed video frames, aggregates operation events into an operation event list, and structures self-report information into a key-value format. Terminal then combines these elements into a user-state input data object including timestamps and a session identifier, and outputs the user-state input data to Server via a secure communication channel.

### Step 2:

Server extracts multimodal user features for emotion estimation.

Server receives the user-state input data from Terminal. The input of Step 2 is the user-state input data object containing an acoustic signal, a visual signal, an operation event list, and self-report information. Server decodes the compressed audio frames to obtain waveform samples, segments the waveform into time frames, and computes acoustic features such as Mel-frequency cepstral coefficients, frame energy values, and fundamental frequency values by applying signal processing operations. Server decodes the compressed video frames into image frames, detects a face region in each frame, and applies a facial landmark detection algorithm to obtain coordinates of facial parts. Server calculates expression features such as eye aspect ratios, eyebrow-eye distances, and mouth corner displacement vectors. Server groups operation events into fixed time windows and calculates behavioral features such as average key interval, key interval variance, error key frequency, and cursor movement speed per window. Server normalizes and aligns these acoustic, visual, and behavioral features with the timestamps of the self-report information, and concatenates them into user-feature vectors. Server outputs the user-feature vectors as input for emotion state estimation.

### Step 3:

Server estimates an emotion state label.

Server loads a trained emotion classification model from storage into main memory. The input of Step 3 is the user-feature vectors produced in Step 2 along with the self-report information. Server inputs each user-feature vector into the emotion classification model, which is implemented as a neural network with multiple layers configured to output a probability distribution over predefined emotion categories such as normal state, high-stress state, anxious state, fatigued state, and confused state. Server computes, for each vector, the probabilities of these categories and selects the category with the highest probability as an initial emotion label. Server then compares this initial emotion label with the self-report information; for example, when the self-reported stress level is above a predetermined threshold, Server adjusts the probabilities to increase the likelihood of the high-stress state and, if necessary, revises the emotion label. Server aggregates labels across a recent time window to smooth short-term fluctuations and outputs a final emotion state label representing the current emotional condition of User.

### Step 4:

Server monitors network traffic and generates traffic feature data.

Server executes monitoring software on its communication interface to capture packets flowing on the protected network. The input of Step 4 is raw packet data duplicated from a mirror port or a network tap. Server aggregates packets into bidirectional or unidirectional flows by grouping packets that share common header fields such as source address, destination address, source port, destination port, and protocol identifier. For each flow, Server records start time, end time, packet count, and byte count. Server constructs flow records as log data and stores them in a log repository. Server then loads these flow records and computes traffic feature values by performing data operations such as calculating flow duration (end time minus start time), bytes per second (byte count divided by duration), packets per second (packet count divided by duration), and an internal/external classification flag based on address ranges. Server normalizes these values using predetermined scaling parameters and packs them into traffic feature vectors. Server outputs the traffic feature vectors for anomaly detection.

### Step 5:

Server detects abnormal traffic and generates abnormal event information.

Server loads a trained normal traffic model, such as an autoencoder network, from storage into memory. The input of Step 5 is the traffic feature vectors produced in Step 4. Server passes each traffic feature vector through the autoencoder and computes a reconstruction error as the difference between the input vector and the reconstructed output vector, using a numerical function such as mean squared error. Server compares the reconstruction error to a predetermined threshold; when the reconstruction error exceeds the threshold, Server determines that the corresponding flow is abnormal. For each abnormal flow, Server compiles abnormal event information including the flow identifiers (source and destination addresses and ports), timestamps, protocol identifier, anomaly score (reconstruction error), and references to the original log data. Server outputs a list of abnormal event information objects representing abnormal traffic to subsequent processing.

### Step 6:

Server generates a prompt sentence for a generative AI model.

Server collects the final emotion state label from Step 3 and the abnormal event information from Step 5. The input of Step 6 is the emotion state label and the set of abnormal event information objects. Server selects a prompt template based on the emotion state label. When the label indicates a high-stress state, Server selects a template emphasizing brevity and clear instructions; when the label indicates a normal state, Server selects a template requesting detailed technical explanation. Server extracts summary elements from the abnormal event information, such as the number of abnormal events, the most severe event with the highest anomaly score, and the relevant time period. Server replaces placeholders in the selected template with these elements to construct a complete prompt sentence in natural language. For example, when the emotion state is high-stress, Server may generate the following prompt sentence as output of Step 6:

“The current administrator is in a high-stress state. Analyze the following abnormal network events:

### [Here, the System Inserts a List of Abnormal Events]

1) Select only the single most critical abnormal event and briefly explain why it is the most critical risk right now.
2) Provide at most three very clear, step-by-step operational actions that the administrator should execute immediately in the security console.
3) List all remaining abnormal events as short ‘to-be-checked-later’ items, each on one line, without detailed explanations.”

As another example, when the emotion state is normal, Server may generate:

“The current administrator is in a normal emotional state and wants detailed technical information. Analyze the following network traffic logs and anomaly detection results:

### [Here, the System Inserts a List of Flows and Anomaly Scores]

1) For each abnormal event, explain the detection rationale, including which traffic features were important, which thresholds or model outputs caused the event to be classified as abnormal, and what the exact anomaly score is.
2) Compare these events with similar historical incidents included in the incident history data, and summarize how those incidents were handled and with what outcome.
3) Propose three concrete and technically sound defense policy adjustments to reduce the likelihood or impact of similar anomalies in the future.”

Server outputs the constructed prompt sentence to the generative AI cooperation module.

### Step 7:

Server obtains response information from the generative AI model.

Server uses a communication library to send the prompt sentence produced in Step 6 to a generative AI model via an application programming interface. The input of Step 7 is the prompt sentence and optional generation parameters such as maximum response length and temperature. Server waits for the generative AI model to generate a natural language response. The generative AI model returns a text string that may include sections describing critical events, immediate action steps, and additional context. Server receives this text and parses it by detecting section headers, numbering, or keyword markers. Server separates the response into components, for example, a summary section containing a description of the most critical abnormal event, an immediate action section containing step-by-step operational instructions, and a supplementary information section listing other abnormal events or policy suggestions. Server structures these components into a response information object that includes labeled text fields and references to the relevant abnormal events. Server outputs this response information for user interface control and defense execution.

### Step 8:

Terminal displays response information and acquires a defense action instruction.

Terminal receives the response information from Server along with the current emotion state label. The input of Step 8 is the response information object and the emotion state label. Terminal determines the appropriate user interface mode based on the emotion state label. When the label indicates a high-stress state, Terminal configures the display to emphasize the summary section and immediate action section, rendering them in large, prominent areas on the screen, while collapsing or hiding the supplementary information section. When the label indicates a normal state, Terminal displays a more detailed view, including tables of abnormal events, explanations, and historical comparisons. Terminal renders interactive controls such as “Execute all recommended actions,” “Execute only first action,” and “Defer” buttons associated with specific recommended defense steps derived from the immediate action section. User reads the displayed information and selects one of the controls according to the situation. When User activates a control, Terminal generates a defense action instruction that encodes the chosen option and any associated event identifiers. Terminal outputs this defense action instruction to Server over the communication channel.

### Step 9:

Server executes defense processing and records feedback data.

Server receives the defense action instruction and the response information from Terminal. The input of Step 9 is the defense action instruction, the response information, and the abnormal event information used earlier. Server interprets the defense action instruction as a selection of particular recommended operations, such as blocking a specific source address, rate-limiting a port, or disabling a user account. Server maps these high-level operations to concrete configuration commands for an access control apparatus or an information processing apparatus. Server constructs command messages conforming to a device management interface protocol, including the target device address, authentication credentials, and configuration parameters. Server transmits the commands to the device and waits for acknowledgments indicating success or failure. After executing the commands, Server resumes monitoring traffic and re-computes anomaly scores for related flows to evaluate the effect of the defense processing. Server calculates defense effectiveness indicators, such as reduction in anomaly scores and change in alert counts for the affected flows. Server collects the emotion state label valid at the time of the defense processing, the list of abnormal events targeted by the commands, the contents of the executed commands, and the defense effectiveness indicators. Server combines these elements into feedback data records and stores them in a feedback database. Server outputs these feedback records for use in future model retraining and system optimization.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

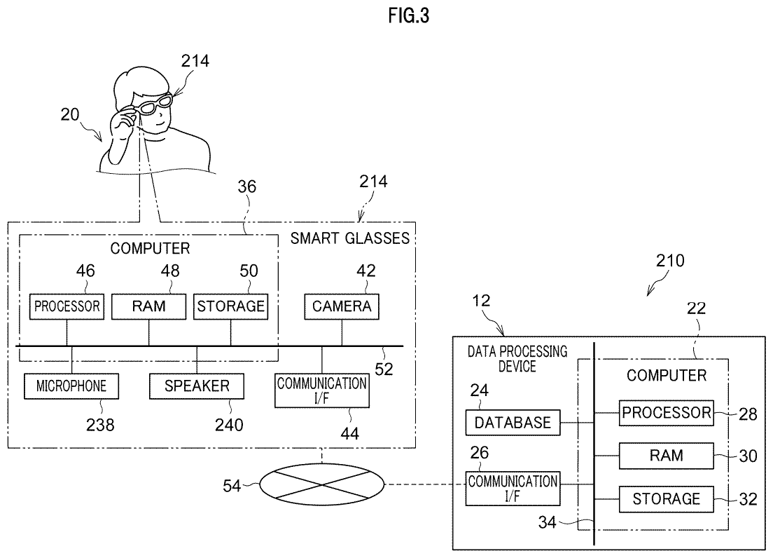

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

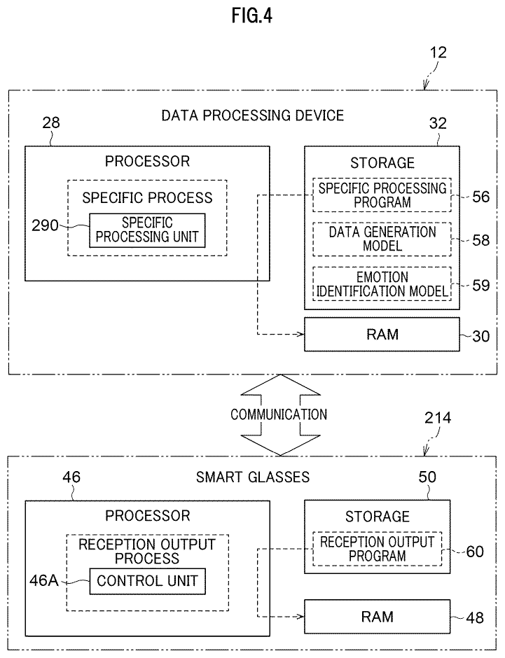

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

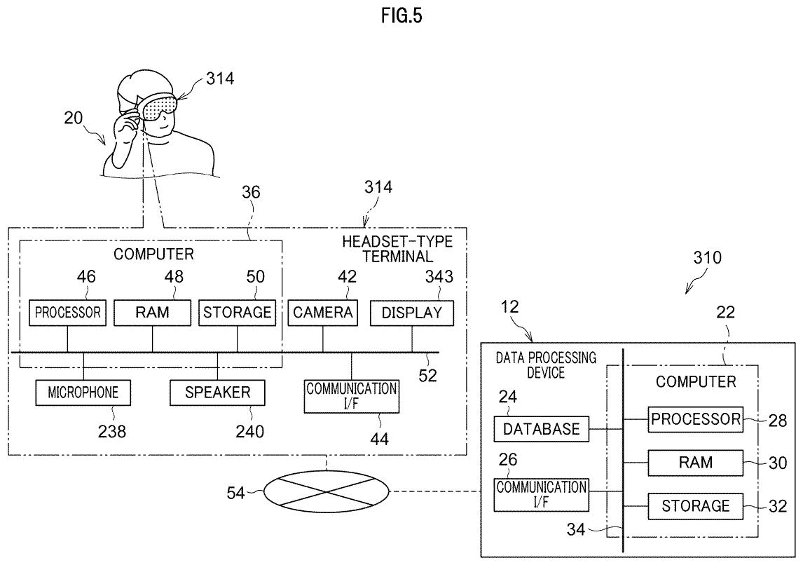

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

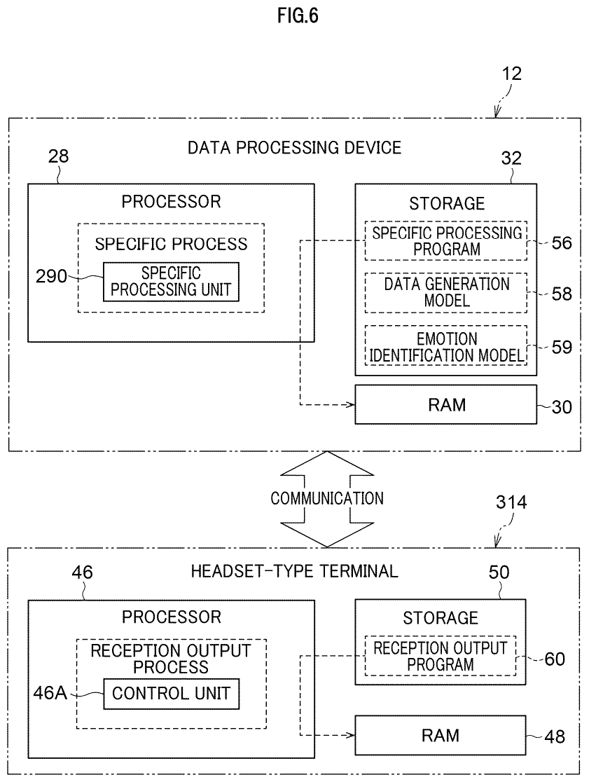

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

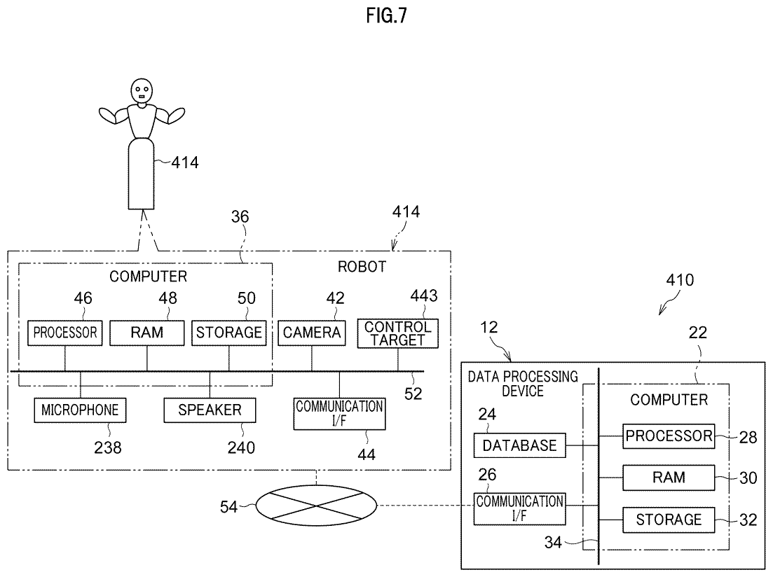

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

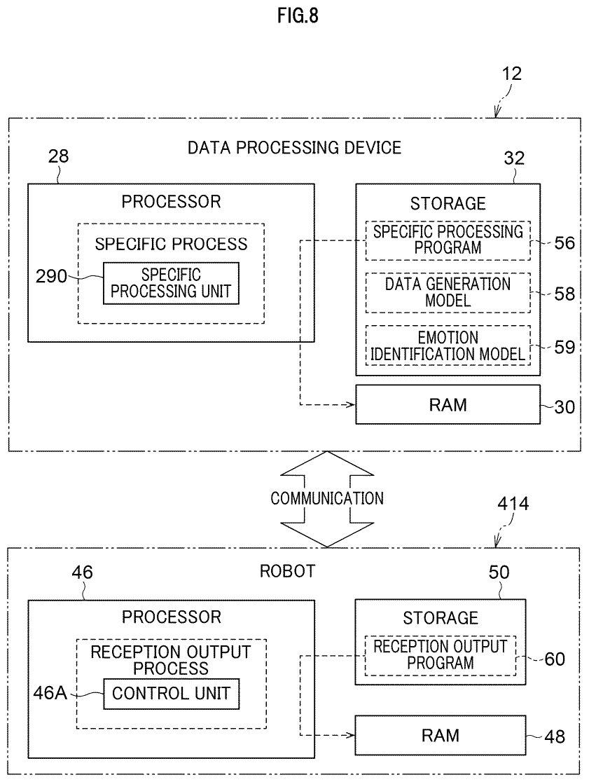

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

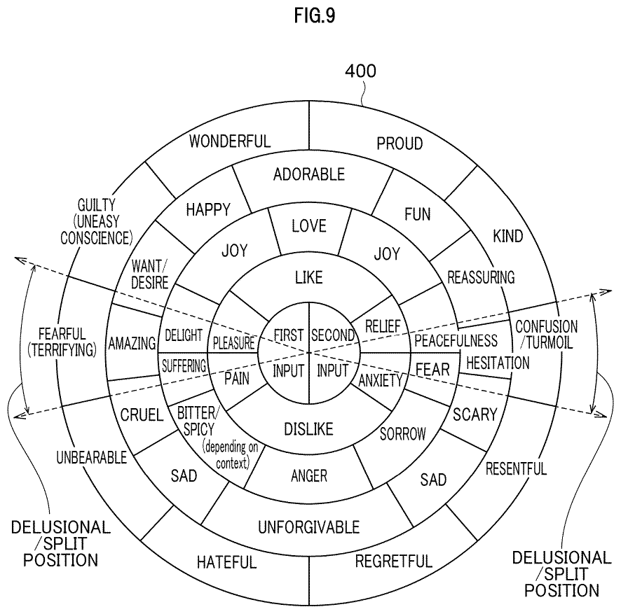

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

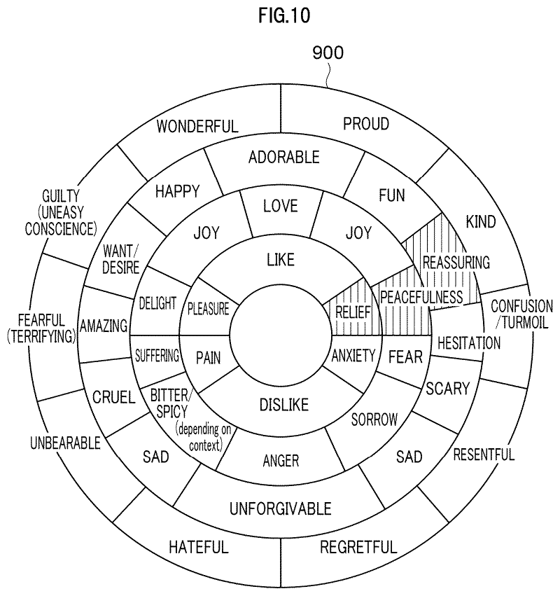

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
collect data related to information security from external information sources and internal information sources, using at least one collection process that acquires document data,
normalizes textual content, and stores structured records in a storage device,
analyze the collected data to extract insights by applying natural language processing and machine learning, including classifying and clustering attack methods and detecting trends and anomalies in the collected data,
generate attack patterns by using the analyzed insights and by supplying a prompt sentence including contextual information about the classified and clustered attack methods to a generative AI model, and by receiving, from the generative AI model, attack pattern data including at least a precondition, a vulnerability type, a procedure, a payload example, and an observation indicator,
develop defense measures by analyzing features contained in the generated attack patterns and by automatically generating at least one of a detection rule, a communication control setting, and a correction process, the developing including updating an intrusion detection rule set, optimizing a firewall configuration, and generating a patch to correct a vulnerability,
evaluate the defense measures by constructing a virtual environment, executing simulated attacks based on the generated attack patterns, collecting evaluation results related to effectiveness of the defense measures, and analyzing the evaluation results,
perform feedback processing by using the evaluation results to improve the defense measures, including generating a prompt sentence that incorporates the attack patterns, candidate defense measures, and the evaluation results, inputting the prompt sentence to the generative AI model, and receiving, from the generative AI model, improved defense proposals for iterative optimization of the defense measures, and
distribute the defense measures to a terminal device and cause the terminal device to apply the distributed defense measures.

### (Supplementary 2)

The system according to supplementary 1,
wherein the processor is configured to
generate the attack patterns by using the security-related data collected from the external information sources and the internal information sources, performing natural language processing and machine learning to classify and cluster attack methods, creating contextual information based on results of the classification and clustering, embedding the contextual information into the prompt sentence supplied to the generative AI model, and causing the generative AI model to output new or variant attack patterns that include the precondition, the vulnerability type, the procedure, the payload example, and the observation indicator.

### (Supplementary 3)

The system according to supplementary 1,
wherein the processor is configured to
develop the defense measures by extracting feature information from the generated attack patterns, automatically generating, based on the feature information, at least one of intrusion detection rules, communication control rules, and program modification content, creating a prompt sentence including the generated attack patterns, candidate defense measures, and evaluation information, inputting the prompt sentence to the generative AI model, receiving, from the generative AI model, adjusted versions of the intrusion detection rules, the communication control rules, and the program modification content, and iteratively optimizing the defense measures based on the adjusted versions and the evaluation results.

### Application Example 1

### (Supplementary 1)

A system comprising a processor,
wherein the processor is configured to
obtain and analyze information,
generate attack behaviors,
generate defense behaviors,
acquire and record communication information,
analyze the communication information and generate feature values,
generate, by a learning process, decision rules representing normal behaviors,
evaluate the communication information using the generated decision rules and detect abnormal behaviors,
update control information of a communication control apparatus on the basis of the detected abnormal behaviors,
record and evaluate results of the defense behaviors, and transmit an input sentence including a prompt sentence to a generative information processing apparatus, obtain output information generated by the generative information processing apparatus based on the input sentence, and use the output information to constitute at least a part of the generation of the attack behaviors, the generation of the defense behaviors, the generation of the feature values, and the generation of the decision rules.

### (Supplementary 2)

The system according to supplementary 1,
wherein the processor is configured to
cause the generative information processing apparatus, as the input sentence including the prompt sentence, to receive an input sentence instructing generation of configuration information defining a recording format, an acquisition period, and a retention period for monitoring and recording the communication information, an input sentence instructing generation of configuration information defining the feature values and a learning method for detecting the abnormal behaviors from the communication information, an input sentence instructing generation of configuration information defining the control information of the communication control apparatus to be applied to the detected abnormal behaviors, and an input sentence instructing generation of configuration information for updating at least a part of the feature values, the decision rules, and the control information based on evaluation results of the defense behaviors, and to generate, in response to these input sentences, the configuration information as the output information, and
obtain the output information and, based on the output information, acquire and analyze the communication information, detect the abnormal behaviors, execute the defense behaviors, and evaluate the defense behaviors.

### (Supplementary 3)

The system according to supplementary 1,
wherein the processor is configured to
store detection results of the abnormal behaviors, evaluation results of the defense behaviors, and determination results by a user, as history information,
generate summary information including the history information and transmit the summary information as the input sentence including the prompt sentence to the generative information processing apparatus,
obtain, from the generative information processing apparatus, output information including threshold update information, information regarding addition or deletion of the feature values, and information regarding automatic execution conditions of the defense behaviors, and automatically update the decision rules, the control information, and execution conditions of the defense behaviors based on the output information.

### Example 2

### (Supplementary 1)

A system comprising a processor,
wherein the processor is configured to function as a data collection unit that acquires security-related information from external information sources and stores the security-related information in a security-related information storage,
wherein the processor is configured to function as an attack pattern generation unit that analyzes the security-related information stored in the security-related information storage by using natural language processing and machine learning, extracts feature information related to attack methods, and generates attack pattern data on the basis of the feature information and the security-related information,
wherein the processor is configured to function as a defense measure development unit that generates defense measure data including intrusion detection rules, communication control rules, program correction data, and user interface warning message candidates on the basis of the attack pattern data,
wherein the processor is configured to function as a simulation evaluation unit that applies the defense measure data to a virtual execution environment, executes simulated attacks in accordance with the attack pattern data in the virtual execution environment, and calculates evaluation indices including at least one of a detection rate, a false positive rate, and a performance impact,
wherein the processor is configured to function as an emotion estimation unit that acquires operation history information and response information from a terminal device on the basis of user operation events and responses to security screens, and estimates an emotional state of a user as emotion scores on the basis of the operation history information and the response information,
wherein the processor is configured to function as a generative artificial intelligence utilization unit that generates a prompt sentence including at least part of the security-related information, the feature information, the attack pattern data, the emotional state, and the evaluation indices calculated by the simulation evaluation unit, inputs the prompt sentence to a generative artificial intelligence model, and causes the generative artificial intelligence model to execute at least part of generation of the attack pattern data, generation of the defense measure data, determination of improvement contents of the defense measure data on the basis of the evaluation indices, and adjustment of wording, frequency, and display timing of warning messages of a user interface, and
wherein the processor is configured to function as a user interface control unit that dynamically controls display wording, display frequency, display timing, and operation request content of the user interface included in the defense measure data on the basis of the emotional state and the evaluation indices calculated by the simulation evaluation unit so as to optimize a balance between user acceptance and a protection level.

### (Supplementary 2)

The system according to supplementary 1,
wherein the processor is configured, in the generative artificial intelligence utilization unit, to include behavior feature quantities calculated from the operation history information and the response information, and user text information, in the prompt sentence, to input the prompt sentence to the generative artificial intelligence model, to cause the generative artificial intelligence model to output numerical scores for a plurality of emotion categories including at least anxiety, confusion, anger, indifference, and relief, and to analyze an output result so as to provide the emotional state to the emotion estimation unit, and
wherein the processor is further configured to include an aggregation result of the emotional state in the prompt sentence and to cause the generative artificial intelligence model to collectively design a network protection policy, a program correction policy, and user interface warning message candidates.

### (Supplementary 3)

The system according to supplementary 1,
wherein the processor is configured, in the generative artificial intelligence utilization unit, to generate the prompt sentence including the defense measure data, the evaluation indices calculated by the simulation evaluation unit including at least one of the detection rate, the false positive rate, and a pop-up display frequency, and distribution information of the emotional state, to input the prompt sentence to the generative artificial intelligence model, and to cause the generative artificial intelligence model to estimate a daily user operation scenario, time-series changes of emotion scores, and factors that cause dissatisfaction and confusion, and
wherein the processor is further configured to determine improvement contents of protection policies and user interface settings including at least one of an upper limit of pop-up frequency, a suppression time, a re-authentication interval, a detection threshold, and a revision of warning wording on the basis of the estimation result, and to continuously and autonomously update the defense measure data and user interface templates.

### Application Example 2

### (Supplementary 1)

A system comprising a processor,
wherein the processor is configured to function as an attack pattern generation unit that acquires security-related information, performs natural language processing on the acquired information, applies machine learning-based analysis to existing attack methods, and generates new attack patterns,
wherein the processor is configured to function as a defense measure development unit that receives the generated attack patterns, analyzes characteristics and weaknesses of the attack patterns, and develops defense measures including updating intrusion detection rules, optimizing access control configurations, and generating corrective data for vulnerabilities,
wherein the processor is configured to function as a simulation evaluation unit that executes virtual attacks using the developed defense measures in a simulated environment and evaluates effectiveness of the defense measures based on results of the virtual attacks,
wherein the processor is configured to function as a network traffic monitoring unit that, by using monitoring software operating on an information processing apparatus, acquires communication data flowing on a communication path and generates log data including source identifiers, destination identifiers, communication control information, data volumes, and time information,
wherein the processor is configured to function as a log data analysis unit that performs statistical processing or machine learning processing on the log data to calculate communication feature values,
wherein the processor is configured to function as an abnormal traffic detection unit that compares the communication feature values with a trained normal traffic model, determines whether traffic is abnormal based on the comparison, and generates abnormal event information,
wherein the processor is configured to function as a user state acquisition unit that, via an input/output apparatus, acquires at least one of an acoustic signal, a visual signal, an operation event signal, and self-report information from an operator,
wherein the processor is configured to function as an emotion state estimation unit that extracts features based on the acoustic signal, the visual signal, the operation event signal, and the self-report information, and estimates an emotion state label including at least one of a normal state, a high-stress state, an anxious state, a fatigued state, and a confused state by using a trained emotion classification model,
wherein the processor is configured to function as a prompt sentence generation unit that dynamically constructs a prompt sentence for a generative AI model based on the emotion state label and the abnormal event information,
wherein the processor is configured to function as a generative AI model cooperation unit that inputs the prompt sentence into the generative AI model, acquires response information output from the generative AI model, and supplies the response information to other units,
wherein the processor is configured to function as a user interface control unit that, based on the emotion state label and the response information, switches an alert presentation method and a level of detail of explanatory content presented on a display apparatus,
wherein the processor is configured to function as a defense execution control unit that, based on the response information and a defense action instruction from the operator, changes settings of an access control apparatus or an information processing apparatus and executes defense processing, and
wherein the processor is configured to function as a feedback recording unit that records, as history information, the emotion state label at a time of the defense processing, the abnormal event information, contents of the defense processing, and a defense effectiveness indicator.

### (Supplementary 2)

The system according to supplementary 1,
wherein the processor is configured to cause the network traffic monitoring unit to generate the log data by acquiring, via the monitoring software, packet information flowing on the communication path, and to cause the log data analysis unit to calculate, as the communication feature values, at least flow duration, data volume per unit time, packet count per unit time, and classification information indicating internal or external communication,
wherein the processor is configured to cause the abnormal traffic detection unit to compare the communication feature values with the trained normal traffic model, compute anomaly scores, and extract, as abnormal traffic, communication flows having anomaly scores greater than a predetermined threshold, thereby generating the abnormal event information including identifiers of the communication flows and the anomaly scores,
wherein the processor is configured to cause the user state acquisition unit to obtain, from the input/output apparatus, the acoustic signal captured by an acoustic sensor, the visual signal captured by an image sensor, the operation event signal generated by an input operation device, and the self-report information input through a user interface, and to structure the obtained data as user state input data,
wherein the processor is configured to cause the emotion state estimation unit to calculate, from the acoustic signal, acoustic features including at least cepstral coefficients, energy, and pitch, to calculate, from the visual signal, expression features including at least geometric relationships among facial parts, to calculate, from the operation event signal, behavior features including at least key operation intervals, error operation frequencies, and pointing operation speeds, to integrate these features with the self-report information, and to input the integrated features into the trained emotion classification model to estimate the emotion state label,
wherein the processor is configured to cause the prompt sentence generation unit to select a prompt template based on the emotion state label and to embed, into the selected prompt template, elements of the abnormal event information including at least a number of abnormal events, a summary of a high-severity event, and a time range, thereby generating the prompt sentence,
wherein the processor is configured to cause the generative AI model cooperation unit to transmit the prompt sentence to the generative AI model via a communication interface, receive a natural language response from the generative AI model, and structurize the natural language response into at least a summary section, an immediate action section, and a supplementary information section as the response information,
wherein the processor is configured to cause the user interface control unit to, when the emotion state label indicates the high-stress state, present on the display apparatus the summary section and the immediate action section with priority and to suppress presentation of detailed log information, and to, when the emotion state label indicates the normal state, enable presentation of detailed abnormal event lists, explanatory texts, and historical comparison information,
wherein the processor is configured to cause the defense execution control unit to interpret the defense action instruction from the operator as a selection of one or more recommended defense operations included in the response information, to convert the recommended defense operations into control commands of the access control apparatus or the information processing apparatus, and to transmit the control commands via a management interface, and
wherein the processor is configured to cause the feedback recording unit to evaluate an effect of the defense processing based on changes in anomaly scores or alert counts after execution of the defense processing and to store the evaluation together with the emotion state label and the contents of the defense processing as feedback data.

### (Supplementary 3)

The system according to supplementary 1,
wherein the processor is configured to cause the prompt sentence generation unit, when the emotion state label indicates the high-stress state, to construct the prompt sentence such that the generative AI model is instructed to select only a single most critical abnormal event from among the abnormal event information, to generate a brief summary explanation of the single most critical abnormal event, to generate a small number of concrete operational steps that the operator should execute immediately, and to list remaining abnormal events as concise items to be checked later,
wherein the processor is configured to cause the prompt sentence generation unit, when the emotion state label indicates the normal state, to construct the prompt sentence such that the generative AI model is instructed to generate, for each abnormal event, a detailed explanation of a detection rationale including used communication feature values and model outputs, a comparative analysis with past defense histories, and proposals of adjustment plans for defense policies, and
wherein the processor is configured to cause the generative AI model cooperation unit to supply response information generated by the generative AI model based on the prompt sentence to the defense measure development unit, the simulation evaluation unit, and the user interface control unit so that the response information is used for designing defense measures, verifying defense effectiveness, and controlling display contents on the display apparatus.

What is claimed is:

1. A system comprising:
a communication interface coupled to a packet-switched network; and
circuitry configured to:
receive, via the communication interface, data regarding security vulnerabilities and technical information from a plurality of information sources;
analyze the received data using natural language processing to generate feature vectors;
analyze existing attack methods using a machine learning process applied to the feature vectors;
generate new attack patterns by transmitting a prompt data structure to a generative neural network model based on the analyzed data and the analyzed existing attack methods;
identify characteristics and weaknesses of attacks represented by the generated attack patterns;
update rule sets of an intrusion detection system, optimize settings of a communication control apparatus, and generate patches for correcting vulnerabilities, based on the identified characteristics and weaknesses;
execute virtual attacks in a simulation environment to verify effectiveness of defense measures including the updated rule sets, the optimized settings, and the generated patches;
improve the defense measures based on results of the executed virtual attacks; and
transmit, via the communication interface, the improved defense measures to a terminal device coupled to the packet-switched network.

2. The system according to claim 1, wherein the circuitry is further configured to analyze the received data by performing tokenization, named entity recognition, and contextual embedding extraction to generate the feature vectors.

3. The system according to claim 1, wherein the circuitry is further configured to analyze the existing attack methods by applying a classification algorithm and a clustering algorithm to the feature vectors to identify attack categories and group related attack methods in a multidimensional vector space.

4. The system according to claim 1, wherein the prompt data structure includes a structured sentence comprising a plurality of field labels, each field label associated with a respective data value derived from the analyzed data and the analyzed existing attack methods.

5. The system according to claim 1, wherein the generative neural network model comprises an embedding layer, a plurality of attention blocks, an output projection layer, and a softmax layer.

6. The system according to claim 1, wherein the circuitry is further configured to:
transmit the improved defense measures and results of the executed virtual attacks to the generative neural network model; and
iteratively regenerate the new attack patterns and the defense measures based on an output of the generative neural network model until a quantitative evaluation metric satisfies a threshold.

7. The system according to claim 1, wherein the simulation environment comprises at least one of a virtual machine or a container configured to replicate a network topology, and wherein the circuitry generates simulated network traffic to execute the virtual attacks against the replicated network topology.

8. The system according to claim 1, wherein the plurality of information sources includes at least one of public vulnerability databases, security advisory reports, technical papers, security-related forums, and blog posts.

9. The system according to claim 1, wherein the circuitry is further configured to:
acquire communication information from a plurality of network devices coupled to the packet-switched network;
generate a plurality of feature values from the acquired communication information; and
detect an abnormal behavior by comparing the plurality of feature values against a normal behavior model trained on historical communication information.

10. The system according to claim 9, wherein the normal behavior model comprises an autoencoder neural network trained to minimize a reconstruction error, and wherein the circuitry detects the abnormal behavior when the reconstruction error for the plurality of feature values exceeds a predetermined threshold.

11. The system according to claim 9, wherein the plurality of feature values includes at least one of a byte count per unit time, a packet count per unit time, a port entropy value, and a failed connection ratio.

12. The system according to claim 9, wherein the circuitry is further configured to transmit the prompt data structure including a description of the detected abnormal behavior to the generative neural network model, and reconfigure at least one of a log schema, a feature extraction parameter, an anomaly detection threshold, and a defense rule based on an output of the generative neural network model.

13. The system according to claim 1, wherein the circuitry is further configured to:
acquire behavioral data associated with an operator of the terminal device; and
estimate an emotion state of the operator based on the acquired behavioral data using an emotion classification model.

14. The system according to claim 13, wherein the emotion state comprises one of a plurality of emotion categories, and wherein the circuitry is further configured to modify the prompt data structure based on the estimated emotion state before transmitting the prompt data structure to the generative neural network model.

15. The system according to claim 13, wherein the behavioral data includes at least one of acoustic features extracted from a voice signal, visual features extracted from a captured image, operation event data including key input intervals and cursor movement speed, and self-report data input by the operator.

16. The system according to claim 13, wherein the circuitry is further configured to dynamically adjust a user interface presented on the terminal device based on the estimated emotion state, including at least one of a notification frequency, a notification wording, and a notification timing.

17. The system according to claim 1, wherein the communication control apparatus comprises at least one of a firewall, an intrusion prevention system, a gateway, and a router, and wherein the circuitry optimizes the settings by updating access control lists or filtering rules of the communication control apparatus.

18. A system comprising:
a communication interface coupled to a packet-switched network, the communication interface including a network interface controller configured to transmit and receive data packets conforming to at least one of Ethernet and wireless communication protocols;
a memory storing instructions and at least one of a trained machine learning model, a trained generative neural network model comprising an embedding layer, a plurality of attention blocks, an output projection layer, and a softmax layer, and a trained normal behavior model; and
circuitry comprising one or more processors coupled to the memory and configured to execute the instructions to:
receive, via the communication interface, data regarding security vulnerabilities and technical information from a plurality of information sources coupled to the packet-switched network;
analyze the received data by performing tokenization, named entity recognition, and contextual embedding extraction using a natural language processing pipeline to generate feature vectors stored in the memory;
analyze existing attack methods by applying a classification algorithm and a clustering algorithm to the feature vectors to identify attack categories and group related attack methods in a multidimensional vector space;
generate new attack patterns by constructing a prompt data structure comprising a structured sentence with a plurality of field labels and respective data values, and transmitting the prompt data structure to the generative neural network model;
identify characteristics and weaknesses of attacks represented by the generated attack patterns;
update rule sets of an intrusion detection system, optimize settings of a communication control apparatus comprising at least one of a firewall and an intrusion prevention system, and generate patches for correcting vulnerabilities, based on the identified characteristics and weaknesses;
execute virtual attacks in a simulation environment comprising at least one of a virtual machine and a container replicating a network topology, to verify effectiveness of defense measures including the updated rule sets, the optimized settings, and the generated patches;
improve the defense measures by iteratively transmitting results of the executed virtual attacks to the generative neural network model and regenerating the defense measures until a quantitative evaluation metric satisfies a predetermined threshold; and
transmit, via the communication interface, the improved defense measures to a terminal device coupled to the packet-switched network.

19. The system according to claim 18, wherein the circuitry is further configured to acquire behavioral data associated with an operator of the terminal device, estimate an emotion state of the operator based on the acquired behavioral data using an emotion classification model stored in the memory, and modify the prompt data structure based on the estimated emotion state before transmitting the prompt data structure to the generative neural network model.

20. A method performed by circuitry of a server coupled to a packet-switched network via a communication interface, the method comprising:
receiving, via the communication interface, data regarding security vulnerabilities and technical information from a plurality of information sources;
analyzing the received data using natural language processing to generate feature vectors;
analyzing existing attack methods using a machine learning process applied to the feature vectors;
generating new attack patterns by transmitting a prompt data structure to a generative neural network model based on the analyzed data and the analyzed existing attack methods;
identifying characteristics and weaknesses of attacks represented by the generated attack patterns;
updating rule sets of an intrusion detection system, optimizing settings of a communication control apparatus, and generating patches for correcting vulnerabilities, based on the identified characteristics and weaknesses;
executing virtual attacks in a simulation environment to verify effectiveness of defense measures including the updated rule sets, the optimized settings, and the generated patches;
improving the defense measures based on results of the executed virtual attacks; and
transmitting, via the communication interface, the improved defense measures to a terminal device coupled to the packet-switched network.
